(19) United States
(12) Patent Application Publication
(10) Pub. No.: US 2023/0300888 A1
(43) Pub. Date: Sep. 21, 2023

(54) METHOD FOR TRANSMITTING/RECEIVING RANDOM ACCESS CHANNEL, AND DEVICE THEREFOR

(71) Applicant: LG Electronics Inc., Seoul (KR)

(72) Inventors: Sunghoon LEE, Seoul (KR); Youngdae LEE, Seoul (KR); Jaehyung KIM, Seoul (KR); Suckchel YANG, Seoul (KR); Seonwook KIM, Seoul (KR)

(21) Appl. No.: 18/006,496

(22) PCT Filed: Jul. 28, 2021
(86) PCT No.: PCT/KR2021/009793

§ 371 Date: Jan. 23, 2023

(30) Foreign Application Priority Data
Aug. 6, 2020 (KR) 10-2020-0098848

(51) Int. Cl. H04W 74/08

(52) U.S. Cl. CPC H04W 74/0833; H04W 74/0891

(57) ABSTRACT

The present disclosure discloses a method by which a terminal for supporting communication related to reduced capability (RedCap) transmits a physical random access channel (PRACH) preamble in a wireless communication system. Particularly, the method comprises: receiving one or more synchronization signal blocks (SSBs); acquiring a random access channel (RACH) occasion to which the first SSB from among the one or more SSBs is mapped; acquiring an initial uplink (UL) bandwidth part (BWP) on the basis of the RACH occasion; and transmitting the TRACH preamble on the basis of the RACH occasion and the initial UL BWP.

### CROSS-REFERENCE TO RELATED APPLICATIONS

This application is a National Stage application under 35 U.S.C. § 371 of International Application No. PCT/KR2021/009793, filed on Jul. 28, 2021, which claims the benefit of Korean Application No. 10-2020-0098848, filed on Aug. 6, 2020. The disclosures of the prior applications are incorporated by reference in their entirety.

### TECHNICAL FIELD

The present disclosure relates to a method for transmitting and receiving a random access channel (RACH) and a device for the same, and more particularly to a method for configuring an initial uplink bandwidth part (BWP) for transmitting and receiving a random access channel (RACH) in a communication system supporting a reduced capability (RedCap) device, and a method for mapping RACH occasion to a synchronization signal block (SSB) and a device for the same.

### BACKGROUND

As more and more communication devices demand larger communication traffic along with the current trends, a future-generation 5th generation (5G) system is required to provide an enhanced wireless broadband communication, compared to the legacy LTE system. In the future-generation 5G system, communication scenarios are divided into enhanced mobile broadband (eMBB), ultra-reliability and low-latency communication (URLLC), massive machine-type communication (mMTC), and so on.

Herein, eMBB is a future-generation mobile communication scenario characterized by high spectral efficiency, high user experienced data rate, and high peak data rate, URLLC is a future-generation mobile communication scenario characterized by ultra-high reliability, ultra-low latency, and ultra-high availability (e.g., vehicle to everything (V2X), emergency service, and remote control), and mMTC is a future-generation mobile communication scenario characterized by low cost, low energy, short packet, and massive connectivity (e.g., Internet of things (IoT)).

### SUMMARY

An object of the present disclosure is to provide a method and device for transmitting and receiving a random access channel (RACH).

It will be appreciated by persons skilled in the art that the objects that could be achieved with the present disclosure are not limited to what has been particularly described hereinabove and the above and other objects that the present disclosure could achieve will be more clearly understood from the following detailed description.

In accordance with an aspect of the present disclosure, a method for transmitting a physical random access channel (PRACH) preamble by a user equipment (UE) supporting communication associated with reduced capability (RedCap) in a wireless communication system may include: receiving at least one synchronization signal block (SSB); obtaining a random access channel (RACH) occasion (RO) to which a first SSB among the at least one SSB is mapped; obtaining an initial uplink (UL) bandwidth part (BWP) based on the RACH occasion (RO); and transmitting the PRACH preamble based on the RACH occasion (RO) and the initial UL BWP.

The initial UL BWP may be an uplink bandwidth part (UL BWP) including the RACH occasion (RO) among a plurality of UL BWPs configured for the UE.

The obtaining the initial UL BWP may include: determining a first frequency higher by a first unit from a first frequency range for the RACH occasion (RO); determining a second frequency lower by the first unit from the first frequency range; and determining a second frequency range from the first frequency to the second frequency to be the initial UL BWP.

The first SSB may be a best SSB in which at least one of a measured received signal strength indicator (RSSI) and a measured reference signal received power (RSRP) has a highest value, among the at least one SSB.

The type of the UE may be informed based on an index of the PRACH preamble.

In accordance with another aspect of the present disclosure, a user equipment (UE) configured to support communication associated with reduced capability (RedCap) for transmitting a physical random access channel (PRACH) preamble in a wireless communication system may include: at least one transceiver; at least one processor; and at least one memory operatively connected to the at least one processor, and configured to store instructions such that the at least one processor performs specific operations by executing the instructions, wherein the specific operations include: receiving at least one synchronization signal block (SSB) through the at least one transceiver; obtaining a random access channel (RACH) occasion (RO) to which a first SSB among the at least one SSB is mapped; obtaining an initial uplink (UL) bandwidth part (BWP) based on the RACH occasion (RO); and transmitting the PRACH preamble based on the RACH occasion (RO) and the initial UL BWP, through the at least one transceiver.

The initial UL BWP may be an uplink bandwidth part (UL BWP) including the RACH occasion (RO) among a plurality of UL BWPs configured for the UE.

The obtaining the initial UL BWP may include: determining a first frequency higher by a first unit from a first frequency range for the RACH occasion (RO); determining a second frequency lower by the first unit from the first frequency range; and determining a second frequency range from the first frequency to the second frequency to be the initial UL BWP.

The first SSB may be a best SSB in which at least one of a measured received signal strength indicator (RSSI) and a measured reference signal received power (RSRP) has a highest value, among the at least one SSB.

The type of the UE may be informed based on an index of the PRACH preamble.

In accordance with another aspect of the present disclosure, a device configured to support communication associated with reduced capability (RedCap) for transmitting a physical random access channel (PRACH) preamble in a wireless communication system may include at least one transceiver; at least one processor; and at least one memory operatively connected to the at least one processor, and configured to store instructions such that the at least one processor performs specific operations by executing the instructions, wherein the specific operations include: receiving at least one synchronization signal block (SSB); obtaining a random access channel (RACH) occasion (RO) to which a first SSB among the at least one SSB is mapped; obtaining an initial uplink (UL) bandwidth part (BWP) based on the RACH occasion (RO); and transmitting the PRACH preamble based on the RACH occasion (RO) and the initial UL BWP.

In accordance with another aspect of the present disclosure, a method for receiving a physical random access channel (PRACH) preamble by a base station (BS) supporting communication associated with reduced capability (RedCap) in a wireless communication system may include transmitting at least one synchronization signal block (SSB); and receiving the PRACH preamble through a random access channel (RACH) occasion (RO) to which a first SSB among the at least one SSB is mapped and an initial uplink (UL) bandwidth part (BWP) which is based on the RACH occasion (RO).

In accordance with another aspect of the present disclosure, a base station (BS) configured to support communication associated with reduced capability (RedCap) for receiving a physical random access channel (PRACH) preamble in a wireless communication system may include: at least one transceiver; at least one processor; and at least one memory operatively connected to the at least one processor, and configured to store instructions such that the at least one processor performs specific operations by executing the instructions, wherein the specific operations include: transmitting, through the at least one transceiver, at least one synchronization signal block (SSB); and receiving, through the at least one transceiver, the PRACH preamble through both a random access channel (RACH) occasion (RO) to which a first SSB from among the at least one SSB is mapped and an initial uplink (UL) bandwidth part (BWP) which is based on the RACH occasion (RO).

In accordance with another aspect of the present disclosure, a computer-readable storage medium configured to store at least one computer program causing at least one processor to perform operations comprising: wherein the operations include: receiving at least one synchronization signal block (SSB); obtaining a random access channel (RACH) occasion (RO) to which a first SSB among the at least one SSB is mapped; obtaining an initial uplink (UL) bandwidth part (BWP) based on the RACH occasion (RO); and transmitting the PRACH preamble based on the RACH occasion (RO) and the initial UL BWP.

As is apparent from the above description, even when RACH Occasion exceeding an initial uplink (UL) BWP (Bandwidth Part) capable of being supported by the RedCap device is configured, the embodiments of the present disclosure can transmit a physical random access channel (PRACH) using a RACH occasion mapped to the best SSB or the 2nd best SSB.

It will be appreciated by persons skilled in the art that the effects that could be achieved with the present disclosure are not limited to what has been particularly described hereinabove and other advantages of the present disclosure will be more clearly understood from the following detailed description.

### BRIEF DESCRIPTION OF THE DRAWINGS

FIG. 1 is a diagram illustrating physical channels and a general signal transmission method using the physical channels in a 3GPP system.

FIGS. 2, 3 and 4 are diagrams illustrating structures of a radio frame and slots used in a new RAT (NR) system.

FIGS. 5, 6, 7, 8, 9 and 10 are diagrams illustrating the composition of a synchronization signal/physical broadcast channel (SS/PBCH) block and a method of transmitting an SS/PBCH block.

FIG. 11 is a diagram illustrating an exemplary 4-step random access channel (RACH) procedure.

FIG. 12 is a diagram illustrating an exemplary 2-step RACH procedure.

FIG. 13 is a diagram illustrating an exemplary contention-free RACH procedure.

FIG. 14 is a diagram illustrating synchronization signal (SS) block transmission and physical random access channel (PRACH) resources linked to SS blocks.

FIG. 15 is a diagram illustrating SS block transmission and PRACH resources linked to SS blocks.

FIG. 16 is a diagram illustrating exemplary RACH occasion configurations.

FIGS. 17 to 19 are diagrams for explaining operations of a user equipment (UE) and a base station (BS) according to embodiments of the present disclosure.

FIG. 20 is a diagram illustrating a method of configuring an initial UL BWP for a RedCap device according to the present disclosure.

FIG. 21 is a diagram illustrating an SSB-RACH occasion mapping method for a RedCap device according to the present disclosure.

FIG. 22 illustrates an exemplary communication system applied to the present disclosure;

FIG. 23 illustrates an exemplary wireless device applicable to the present disclosure; and

FIG. 24 illustrates an exemplary vehicle or autonomous driving vehicle applicable to the present disclosure.

### DETAILED DESCRIPTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

While the following description is given in the context of a 3GPP communication system (e.g., NR) for clarity, the technical spirit of the present disclosure is not limited to the 3GPP communication system. For the background art, terms, and abbreviations used in the present disclosure, refer to the technical specifications published before the present disclosure (e.g., 38.211, 38.212, 38.213, 38.214, 38.300, 38.331, and so on).

5G communication involving a new radio access technology (NR) system will be described below.

Three key requirement areas of 5G are (1) enhanced mobile broadband (eMBB), (2) massive machine type communication (mMTC), and (3) ultra-reliable and low latency communications (URLLC).

Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is AR for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases in a 5G communication system including the NR system will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup may be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G.

Finally, logistics and freight tracking are important use cases for mobile communications that enable the tracking of inventory and packages wherever they are by using location-based information systems. The logistics and freight tracking use cases typically require lower data rates but need wide coverage and reliable location information.

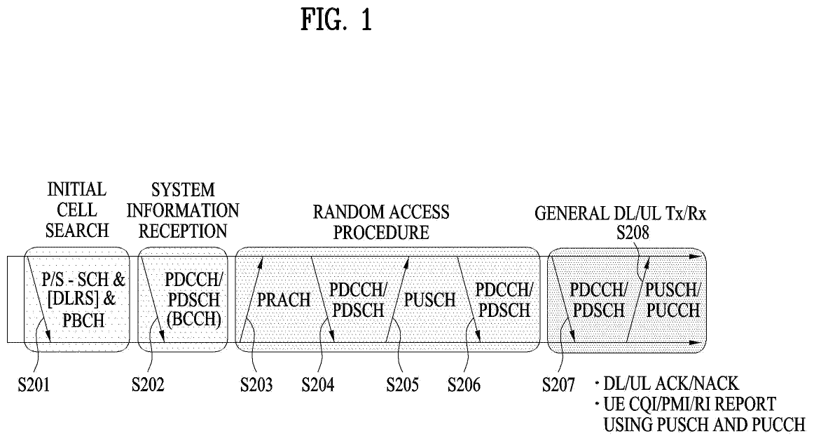

FIG. 1 illustrates physical channels and a general method for transmitting signals on the physical channels in the 3GPP system.

Referring to FIG. 1, when a UE is powered on or enters a new cell, the UE performs initial cell search (S201). The initial cell search involves acquisition of synchronization to an eNB. Specifically, the UE synchronizes its timing to the eNB and acquires a cell identifier (ID) and other information by receiving a primary synchronization channel (P-SCH) and a secondary synchronization channel (S-SCH) from the eNB. Then the UE may acquire information broadcast in the cell by receiving a physical broadcast channel (PBCH) from the eNB. During the initial cell search, the UE may monitor a DL channel state by receiving a downlink reference signal (DL RS).

After the initial cell search, the UE may acquire detailed system information by receiving a physical downlink control channel (PDCCH) and receiving a physical downlink shared channel (PDSCH) based on information included in the PDCCH (S202).

If the UE initially accesses the eNB or has no radio resources for signal transmission to the eNB, the UE may perform a random access procedure with the eNB (S203 to S206). In the random access procedure, the UE may transmit a predetermined sequence as a preamble on a physical random access channel (PRACH) (S203 and S205) and may receive a response message to the preamble on a PDCCH and a PDSCH associated with the PDCCH (S204 and S206). In the case of a contention-based RACH, the UE may additionally perform a contention resolution procedure.

After the above procedure, the UE may receive a PDCCH and/or a PDSCH from the eNB (S207) and transmit a physical uplink shared channel (PUSCH) and/or a physical uplink control channel (PUCCH) to the eNB (S208), which is a general DL and UL signal transmission procedure. Particularly, the UE receives downlink control information (DCI) on a PDCCH. Herein, the DCI includes control information such as resource allocation information for the UE. Different DCI formats are defined according to different usages of DCI.

Control information that the UE transmits to the eNB on the UL or receives from the eNB on the DL includes a DL/UL acknowledgment/negative acknowledgment (ACK/NACK) signal, a channel quality indicator (CQI), a precoding matrix index (PMI), a rank indicator (RI), etc. In the 3GPP LTE system, the UE may transmit control information such as a CQI, a PMI, an RI, etc. on a PUSCH and/or a PUCCH.

The use of an ultra-high frequency band, that is, a millimeter frequency band at or above 6 GHz is under consideration in the NR system to transmit data in a wide frequency band, while maintaining a high transmission rate for multiple users. The 3GPP calls this system NR. In the present disclosure, the system will also be referred to as an NR system.

The NR system adopts the OFDM transmission scheme or a similar transmission scheme. Specifically, the NR system may use OFDM parameters different from those in LTE. Further, the NR system may follow the legacy LTE/LTE-A numerology but have a larger system bandwidth (e.g., 100 MHz). Further, one cell may support a plurality of numerologies in the NR system. That is, UEs operating with different numerologies may coexist within one cell.

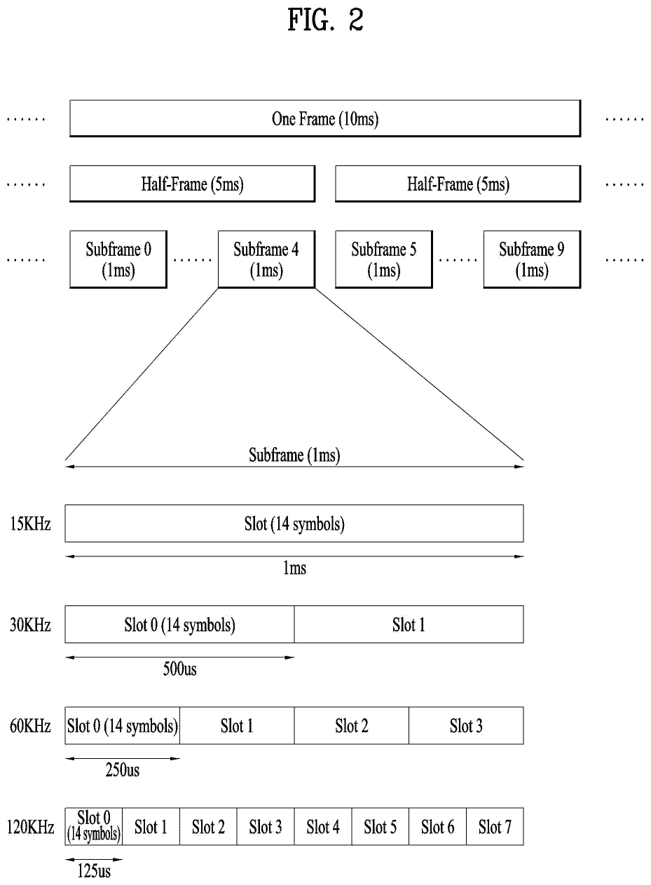

FIG. 2 illustrates a structure of a radio frame used in NR.

In NR, UL and DL transmissions are configured in frames. The radio frame has a length of 10 ms and is defined as two 5-ms half-frames (HF). The half-frame is defined as five 1 ms subframes (SF). A subframe is divided into one or more slots, and the number of slots in a subframe depends on subcarrier spacing (SCS). Each slot includes 12 or 14 OFDM(A) symbols according to a cyclic prefix (CP). When a normal CP is used, each slot includes 14 symbols. When an extended CP is used, each slot includes 12 symbols. Here, the symbols may include OFDM symbols (or CP-OFDM symbols) and SC-FDMA symbols (or DFT-s-OFDM symbols).

[Table 1] illustrates that the number of symbols per slot, the number of slots per frame, and the number of slots per subframe vary according to the SCS when the normal CP is used.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

* N^{slot}_{symb}: number of symbols in a slot
* N^{frame, u}ₛₗₒₜ: number of slots in a frame
* N^{subframe, u}ₛₗₒₜ: number of slots in a subframe

Table 2 illustrates that the number of symbols per slot, the number of slots per frame, and the number of slots per subframe vary according to the SCS when the extended CP is used.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In the NR system, the OFDM(A) numerology (e.g., SCS, CP length, etc.) may be configured differently among a plurality of cells merged for one UE. Thus, the (absolute time) duration of a time resource (e.g., SF, slot or TTI) (referred to as a time unit (TU) for simplicity) composed of the same number of symbols may be set differently among the merged cells.

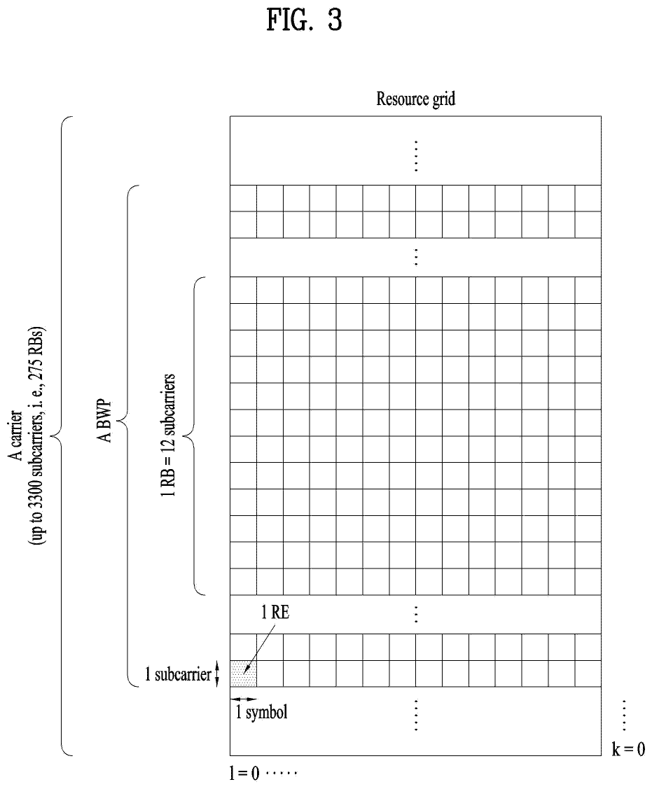

FIG. 3 illustrates a slot structure of an NR frame. A slot includes a plurality of symbols in the time domain. For example, in the case of the normal CP, one slot includes seven symbols. On the other hand, in the case of the extended CP, one slot includes six symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) is defined as a plurality of consecutive (P)RBs in the frequency domain and may correspond to one numerology (e.g., SCS, CP length, etc.). A carrier may include up to N (e.g., five) BWPs. Data communication is performed through an activated BWP, and only one BWP may be activated for one UE. In the resource grid, each element is referred to as a resource element (RE), and one complex symbol may be mapped thereto.

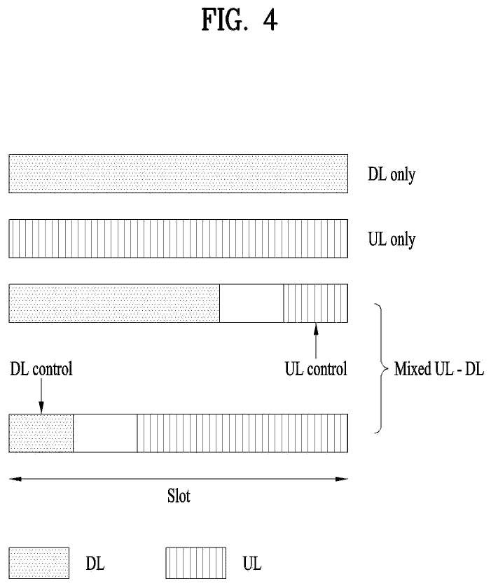

FIG. 4 illustrates a structure of a self-contained slot. In the NR system, a frame has a self-contained structure in which a DL control channel, DL or UL data, a UL control channel, and the like may all be contained in one slot. For example, the first N symbols (hereinafter, DL control region) in the slot may be used to transmit a DL control channel, and the last M symbols (hereinafter, UL control region) in the slot may be used to transmit a UL control channel. N and M are integers greater than or equal to 0. A resource region (hereinafter, a data region) that is between the DL control region and the UL control region may be used for DL data transmission or UL data transmission. For example, the following configuration may be considered. Respective sections are listed in a temporal order.
1. DL only configuration
2. UL only configuration
3. Mixed UL-DL configuration
   DL region+Guard period (GP)+UL control region
   DL control region+GP+UL region
      DL region: (i) DL data region, (ii) DL control region+DL data region
      UL region: (i) UL data region, (ii) UL data region+UL control region

The PDCCH may be transmitted in the DL control region, and the PDSCH may be transmitted in the DL data region. The PUCCH may be transmitted in the UL control region, and the PUSCH may be transmitted in the UL data region. Downlink control information (DCI), for example, DL data scheduling information, UL data scheduling information, and the like, may be transmitted on the PDCCH. Uplink control information (UCI), for example, ACK/NACK information about DL data, channel state information (CSI), and a scheduling request (SR), may be transmitted on the PUCCH. The GP provides a time gap in the process of the UE switching from the transmission mode to the reception mode or from the reception mode to the transmission mode. Some symbols at the time of switching from DL to UL within a subframe may be configured as the GP.

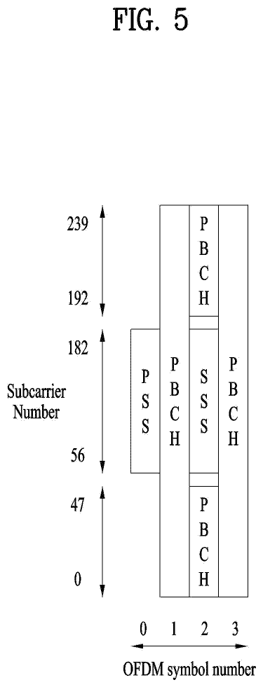

FIG. 5 illustrates a synchronization signal block (SSB) structure. The UE may perform cell search, system information acquisition, beam alignment for initial access, DL measurement, and so on based on an SSB. The term SSB is used interchangeably with synchronization signal/physical broadcast channel (SS/PBCH) block.

Referring to FIG. 5, an SSB is composed of a PSS, an SSS, and a PBCH. The SSB includes four consecutive OFDM symbols. The PSS, the PBCH, the SSS/PBCH, and the PBCH are transmitted on the respective OFDM symbols. Each of the PSS and the SSS includes one OFDM symbol and 127 subcarriers, and the PBCH includes 3 OFDM symbols and 576 subcarriers. Polar coding and quadrature phase shift keying (QPSK) are applied to the PBCH. The PBCH includes data REs and demodulation reference signal (DMRS) REs in each OFDM symbol. There are three DMRS REs per RB, with three data REs between every two adjacent DMRS REs.

Cell Search

The cell search refers to a procedure in which the UE obtains time/frequency synchronization of a cell and detects a cell ID (e.g., physical layer cell ID (POD)) of the cell. The PSS may be used in detecting a cell ID within a cell ID group, and the SSS may be used in detecting a cell ID group. The PBCH may be used in detecting an SSB (time) index and a half-frame.

The cell search procedure of the UE may be summarized as described in Table 3 below.

TABLE 3

| | Type of | |
|---|---|---|
| | Signals | Operations |
| 1^{st} | PSS | SS/PBCH block (SSB) symbol timing acquisition |
| step | | Cell ID detection within a cell ID group |
| | | (3 hypothesis) |
| 2^{nd} | SSS | Cell ID group detection |
| Step | | (336 hypothesis) |
| 3^{rd} | PBCH | SSB index and Half frame (HF) index |
| Step | DMRS | (Slot and frame boundary detection) |
| 4^{th} | PBCH | Time information (80 ms, System Frame Number |
| Step | | (SFN), SSB index, HF) |
| | | Remaining Minimum System Information (RMSI) |
| | | Control resource set (CORESET)/Search |
| | | space configuration |
| 5^{th} | PDCCH and | Cell access information |
| Step | PDSCH | RACH configuration |

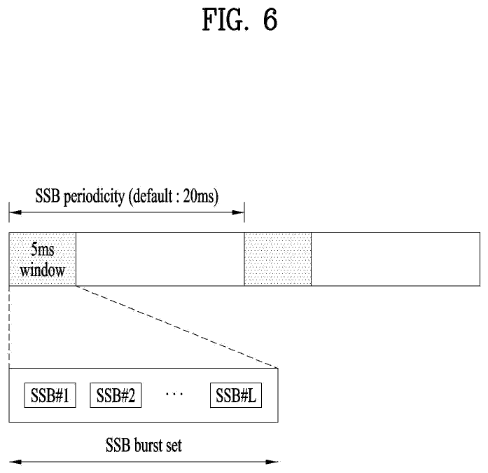

FIG. 6 illustrates SSB transmission.

Referring to FIG. 6, an SSB is periodically transmitted according to the SSB periodicity. The basic SSB periodicity assumed by the UE in the initial cell search is defined as 20 ms. After the cell access, the SSB periodicity may be set to one of {5 ms, 10 ms, 20 ms, 40 ms, 80 ms, 160 ms} by the network (e.g., the BS). An SSB burst set may be configured at the beginning of an SSB period. The SSB burst set may be configured with a 5-ms time window (i.e., half-frame), and an SSB may be repeatedly transmitted up to L times within the SS burst set. The maximum number of transmissions of the SSB, L may be given according to the frequency band of a carrier as follows. One slot includes up to two SSBs.
For frequency range up to 3 GHz, L=4
For frequency range from 3 GHz to 6 GHz, L=8
For frequency range from 6 GHz to 52.6 GHz, L=64

The time position of an SSB candidate in the SS burst set may be defined according to the SCS as follows. The time positions of SSB candidates are indexed as (SSB indexes) 0 to L−1 in temporal order within the SSB burst set (i.e., half-frame).
Case A—15-kHz SCS: The indexes of the first symbols of candidate SSBs are given as {2, 8}+14*n where n=0, 1 for a carrier frequency equal to or lower than 3 GHz, and n=0, 1, 2, 3 for a carrier frequency of 3 GHz to 6 GHz.
Case B—30-kHz SCS: The indexes of the first symbols of candidate SSBs are given as {4, 8, 16, 20}+28*n where n=0 for a carrier frequency equal to or lower than 3 GHz, and n=0, 1 for a carrier frequency of 3 GHz to 6 GHz.
Case C—30-kHz SCS: The indexes of the first symbols of candidate SSBs are given as {2, 8}+14*n where n=0, 1 for a carrier frequency equal to or lower than 3 GHz, and n=0, 1, 2, 3 for a carrier frequency of 3 GHz to 6 GHz.
Case D—120-kHz SCS: The indexes of the first symbols of candidate SSBs are given as {4, 8, 16, 20}+28*n where n=0, 1, 2, 3, 5, 6, 7, 8, 10, 11, 12, 13, 15, 16, 17, 18 for a carrier frequency above 6 GHz.
Case E—240-kHz SCS: The indexes of the first symbols of candidate SSBs are given as {8, 12, 16, 20, 32, 36, 40, 44}+56*n where n=0, 1, 2, 3, 5, 6, 7, 8 for a carrier frequency above 6 GHz.

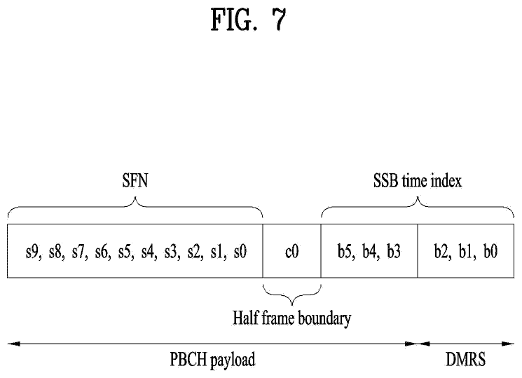

FIG. 7 illustrates exemplary acquisition of information about DL time synchronization at a UE.

Referring to FIG. 7, the UE may acquire DL synchronization by detecting an SSB. The UE may identify the structure of an SSB burst set based on the index of the detected SSB, and thus detect a symbol/slot/half-frame boundary. The number of a frame/half-frame to which the detected SSB belongs may be identified by SFN information and half-frame indication information.

Specifically, the UE may acquire 10-bit SFN information, s0 to s9 from a PBCH. 6 bits of the 10-bit SFN information is acquired from a master information block (MIB), and the remaining 4 bits is acquired from a PBCH transport block (TB).

Subsequently, the UE may acquire 1-bit half-frame indication information c0. If a carrier frequency is 3 GH or below, the half-frame indication information may be signaled implicitly by a PBCH DMRS. The PBCH DMRS indicates 3-bit information by using one of 8 PBCH DMRS sequences. Therefore, if L=4, the remaining one bit except for two bits indicating an SSB index in the 3-bit information which may be indicated by 8 PBCH DMRS sequences may be used for half-frame indication.

Finally, the UE may acquire an SSB index based on the DMRS sequence and the PBCH payload. SSB candidates are indexed from 0 to L−1 in a time order within an SSB burst set (i.e., half-frame). If L=8 or 64, three least significant bits (LSBs) b0 to b2 of the SSB index may be indicated by 8 different PBCH DMRS sequences. If L=64, three most significant bits (MSBs) b3 to b5 of the SSB index is indicated by the PBCH. If L=2, two LSBs b0 and b1 of an SSB index may be indicated by 4 different PBCH DMRS sequences. If L=4, the remaining one bit b2 except for two bits indicating an SSB index in 3-bit information which may be indicated by 8 PBCH DMRS sequences may be used for half-frame indication.

System Information Acquisition

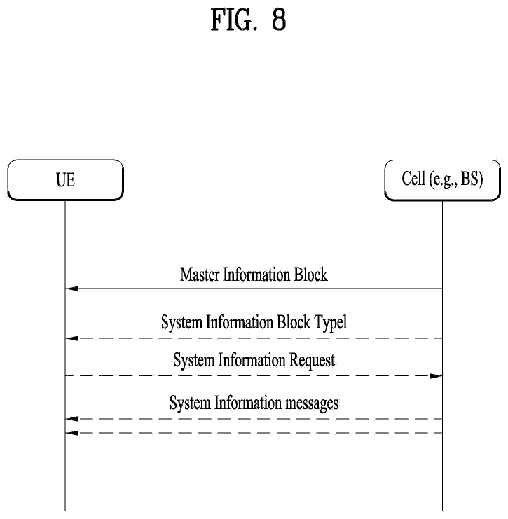

FIG. 8 illustrates a system information (SI) acquisition procedure. The UE may obtain access stratum (AS)-/non-access stratum (NAS)-information in the SI acquisition procedure. The SI acquisition procedure may be applied to UEs in RRC_IDLE, RRC_INACTIVE, and RRC_CONNECTED states.

SI is divided into a master information block (MIB) and a plurality of system information blocks (SIBs). The MIB and the plurality of SIBs are further divided into minimum SI and other SI. The minimum SI may include the MIB and systemInformationBlock1 (SIB1), carrying basic information required for initial access and information required to obtain the other SI. SIB1 may also be referred to as remaining minimum system information (RMSI). For details, the following may be referred to.
The MIB includes information/parameters related to reception of SIB1 and is transmitted on the PBCH of an SSB. The UE assumes that a half-frame including an SSB is repeated every 20 ms during initial cell selection. The UE may determine from the MIB whether there is any control resource set (CORESET) for a Type0-PDCCH common search space. The Type0-PDCCH common search space is a kind of PDCCH search space and used to transmit a PDCCH that schedules an SI message. In the presence of a Type0-PDCCH common search space, the UE may determine (1) a plurality of contiguous RBs and one or more consecutive symbols included in a CORESET, and (ii) a PDCCH occasion (e.g., a time-domain position at which a PDCCH is to be received), based on information (e.g., pdcch-ConfigSIB1) included in the MIB. In the absence of a Type0-PDCCH common search space, pdcch-ConfigSIB1 provides information about a frequency position at which the SSB/SIB1 exists and information about a frequency range without any SSB/SIB1.
SIB1 includes information related to availability and scheduling (e.g., a transmission periodicity and an SI-window size) of the remaining SIBS (hereinafter, referred to as SIBx where x is an integer equal to or larger than 2). For example, SIB1 may indicate whether SIBx is broadcast periodically or in an on-demand manner upon UE request. If SIBx is provided in the on-demand manner, SIB1 may include information required for the UE to transmit an SI request. A PDCCH that schedules SIB1 is transmitted in the Type0-PDCCH common search space, and SIB1 is transmitted on a PDSCH indicated by the PDCCH.
SIBx is included in an SI message and transmitted on a PDSCH. Each SI message is transmitted within a periodic time window (i.e., SI-window).

Beam Alignment

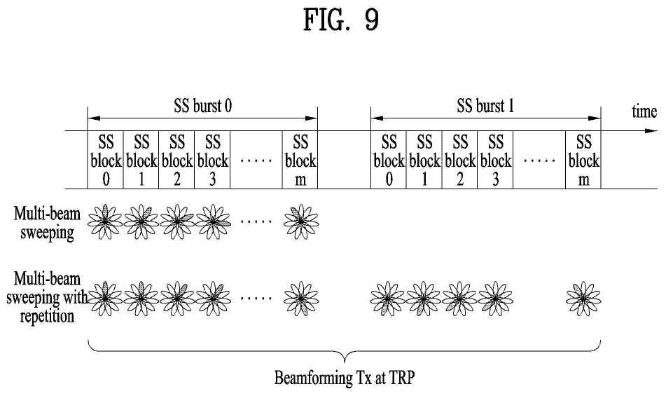

FIG. 9 illustrates exemplary multi-beam transmission of SSBs.

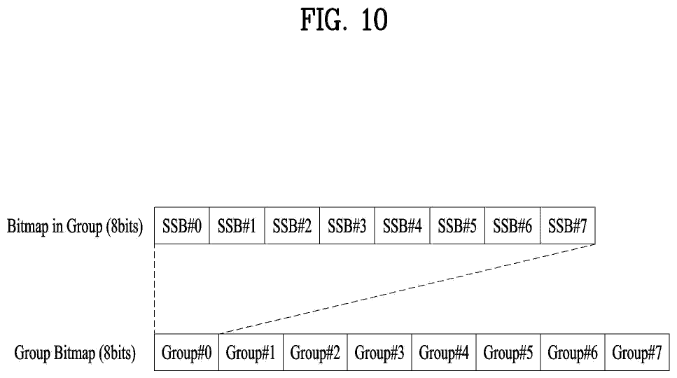

Beam sweeping refers to changing the beam (direction) of a wireless signal over time at a transmission reception point (TRP) (e.g., a BS/cell) (hereinafter, the terms beam and beam direction are interchangeably used). Referring to FIG. 10, an SSB may be transmitted periodically by beam sweeping. In this case, SSB indexes are implicitly linked to SSB beams. An SSB beam may be changed on an SSB (index) basis or on an SS (index) group basis. In the latter, the same SSB beam is maintained in an SSB (index) group. That is, the transmission beam direction of an SSB is repeated for a plurality of successive SSBs. The maximum allowed transmission number L of an SSB in an SSB burst set is 4, 8 or 64 according to the frequency band of a carrier. Accordingly, the maximum number of SSB beams in the SSB burst set may be given according to the frequency band of a carrier as follows.
For frequency range of up to 3 GHz, maximum number of beams=4
For frequency range from 3 GHz to 6 GHz, maximum number of beams=8
For frequency range from 6 GHz to 52.6 GHz, maximum number of beams=64

Without multi-beam transmission, the number of SSB beams is 1.

When the UE attempts initial access to the BS, the UE may align beams with the BS based on an SSB. For example, the UE performs SSB detection and then identifies a best SSB. Subsequently, the UE may transmit an RACH preamble in PRACH resources linked/corresponding to the index (i.e., beam) of the best SSB. The SSB may also be used for beam alignment between the BS and the UE even after the initial access.

Channel Estimation and Rate-Matching

FIG. 10 illustrates an exemplary method of indicating actually transmitted SSBs, SSB_tx.

Up to L SSBs may be transmitted in an SSB burst set, and the number and positions of actually transmitted SSBs may be different for each BS or cell. The number and positions of actually transmitted SSBs are used for rate-matching and measurement, and information about actually transmitted SSBs is indicated as follows.
If the information is related to rate matching, the information may be indicated by UE-specific RRC signaling or RMSI. The UE-specific RRC signaling includes a full bitmap (e.g., of length L) for frequency ranges below and above 6 GHz. The RMSI includes a full bitmap for a frequency range below 6 GHz and a compressed bitmap for a frequency range above 6 GHz, as illustrated. Specifically, the information about actually transmitted SSBs may be indicated by a group-bitmap (8 bits)+an in-group bitmap (8 bits). Resources (e.g., REs) indicated by the UE-specific RRC signaling or the RMSI may be reserved for SSB transmission, and a PDSCH and/or a PUSCH may be rate-matched in consideration of the SSB resources.
If the information is related to measurement, the network (e.g., BS) may indicate an SSB set to be measured within a measurement period, when the UE is in RRC connected mode. The SSB set may be indicated for each frequency layer. Without an indication of an SSB set, a default SSB set is used. The default SSB set includes all SSBs within the measurement period. An SSB set may be indicated by a full bitmap (e.g., of length L) in RRC signaling. When the UE is in RRC idle mode, the default SSB set is used.

In the NR system, a massive multiple input multiple output (MIMO) environment in which the number of transmission/reception (Tx/Rx) antennas is significantly increased may be under consideration. That is, as the massive MIMO environment is considered, the number of Tx/Rx antennas may be increased to a few tens or hundreds. The NR system supports communication in an above 6 GHz band, that is, a millimeter frequency band. However, the millimeter frequency band is characterized by the frequency property that a signal is very rapidly attenuated according to a distance due to the use of too high a frequency band. Therefore, in an NR system operating at or above 6 GHz, beamforming (BF) is considered, in which a signal is transmitted with concentrated energy in a specific direction, not omni-directionally, to compensate for rapid propagation attenuation. Accordingly, there is a need for hybrid BF with analog BF and digital BF in combination according to a position to which a BF weight vector/precoding vector is applied, for the purpose of increased performance, flexible resource allocation, and easiness of frequency-wise beam control in the massive MIMO environment.

Random Access Channel (RACH) Procedure

When a UE first accesses a BS or has no radio resource for signal transmission, the UE may perform a RACH procedure to the BS.

The RACH procedure may be used for various purposes. For example, the RACH procedure may be used for initial network access from RRC_IDLE, an RRC connection re-establishment procedure, handover, UE-triggered UL data transmission, transition from RRC_INACTIVE, time alignment establishment in SCell addition, other system information (OSI) request and beam failure recovery, and so on. The UE may acquire UL synchronization and UL transmission resources from the RACH procedure.

The RACH procedure may be divided into a contention-based RACH procedure and a contention-free RACH procedure. The contention-based RACH procedure may be divided into a 4-step RACH procedure (4-step RACH) and a 2-step RACH procedure (2-step RACH).

(1) 4-Step RACH: Type-1 Random Access Procedure

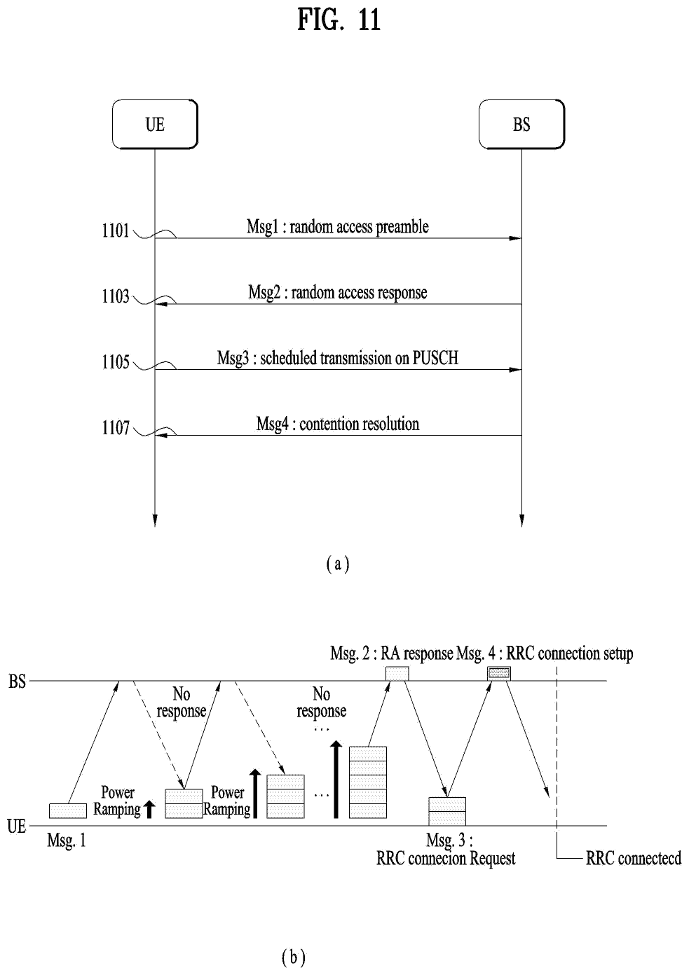

FIG. 11 is a diagram illustrating an exemplary 4-step RACH procedure.

If the (contention-based) RACH procedure is performed in four steps (i.e., 4-step RACH procedure), the UE may transmit a message (message 1 (Msg1)) including a preamble related to a specific sequence on a physical random access channel (PRACH) (1101) and may receive a response message (random access response (RAR) message) (message 2 (Msg2)) to the preamble on a PDCCH and a PDSCH related thereto (1103). The UE may transmit a message (message 3 (Msg3)) including a PUSCH based on scheduling information in the RAR (1105). The UE may perform a contention resolution procedure by receiving a PDCCH signal and a PDSCH signal related thereto. To this end, the UE may receive a message (message 4 (Msg4)) containing contention resolution information on the contention resolution procedure from the BS (1107).

The 4-step RACH procedure of the UE may be summarized as shown in Table 4 below.

TABLE 4

| | Type of | Operations/Information |
|---|---|---|
| | Signals | Acquired |
| 1^{st} | PRACH preamble | Initial beam acquisition |
| step | in UL | Random election of RA-preamble ID |
| 2^{nd} | Random Access | Timing alignment information |
| Step | Response on | RA-preamble ID |
| | DL-SCH | Initial UL grant, Temporary C-RNTI |
| 3^{rd} | UL transmission | RRC connection request |
| Step | on UL-SCH | UE identifier |
| 4^{th} | Contention | Temporary C-RNTI on PDCCH for |
| Step | Resolution | initial access |
| | on DL | C-RNTI on PDCCH for UE in |
| | | RRC_CONNECTED |

First, the UE may transmit a random access preamble over a PRACH in UL as Msg1 of the RACH procedure.

Random access preamble sequences of two different lengths are supported. Long sequence length 839 is applied with SCSs of 1.25 and 5 kHz, and short sequence length 139 is applied with SCSs of 15, 30, 60 and 120 kHz.

Multiple preamble formats are defined by one or more RACH OFDM symbols and different cyclic prefixes (and/or guard times). The RACH configuration for the initial bandwidth of a primary cell (Pcell) may be included in system information of the cell and provided to the UE. The RACH configuration includes information on the SCS of the PRACH, available preambles, preamble formats, and the like. The RACH configuration includes information on association between SSBs and RACH (time-frequency) resources. The UE transmits the random access preamble on a RACH time-frequency resource associated with a detected or selected SSB.

The threshold of SSBs may be configured by the network for association with RACH resources. The RACH preamble may be transmitted or retransmitted based on SSB(s) having reference signal received power (RSRP) measured based thereon satisfying the threshold. For example, the UE may select one of the SSB(s) that satisfy the threshold and transmit or retransmit the RACH preamble based on a RACH resource associated with the selected SSB. For example, upon retransmission of the RACH preamble, the UE may reselect one of the SSB(s) and retransmit the RACH preamble based on a RACH resource associated with the reselected SSB. That is, the RACH resource for retransmission of the RACH preamble may be the same as and/or different from the RACH resource for transmission of the RACH preamble.

When the BS receives a random access preamble from the UE, the BS transmits an RAR message (Msg2) to the UE. A PDCCH scheduling a PDSCH carrying the RAR is cyclic redundancy check (CRC) scrambled with a random access (RA) radio network temporary identifier (RNTI) (RA-RNTI) and then transmitted. Upon detecting the PDCCH CRC-scrambled with the RA-RNTI, the UE may receive the RAR from the PDSCH scheduled by DCI carried on the PDCCH. The UE checks whether the RAR includes RAR information in response to the preamble transmitted by the UE, i.e., Msg1. The presence or absence of the RAR information in response to Msg1 transmitted by the UE may be determined depending on whether there is a random access preamble ID for the preamble transmitted by the UE. If there is no response to Msg1, the UE may retransmit the RACH preamble within a predetermined number of times while performing power ramping. The UE may calculate PRACH transmission power for retransmitting the preamble based on the most recent transmission power, power increment, and power ramping counter.

The RAR information may include a preamble sequence transmitted by the UE, a temporary cell-RNTI (TC-RNTI) allocated by the BS to the UE that has attempted random access, and UL transmit time alignment information, UL transmission power adjustment information, and UL radio resource allocation information. If the UE receives the RAR information for itself on the PDSCH, the UE may obtain timing advance information for UL synchronization, an initial UL grant, a TC-RNTI. The timing advance information may be used to control a UL signal transmission timing. To better align PUSCH/PUCCH transmission by the UE with the subframe timing at the network, the network (e.g., BS) may obtain the timing advance information based on timing information detected from a PRACH preamble received from the UE and transmit the timing advance information to the UE. The UE may transmit a UL signal over a UL shared channel based on the RAR information as Msg3 of the RACH procedure. Msg3 may include an RRC connection request and a UE identifier. In response to Msg3, the network may transmit Msg4, which may be treated as a contention resolution message on DL. Upon receiving Msg4, the UE may enter the RRC_CONNECTED state.

As described above, a UL grant in the RAR may schedule PUSCH transmission to the BS. A PUSCH carrying initial UL transmission based on the UL grant in the RAR is also referred to as a Msg3 PUSCH. The content of an RAR UL grant may start at the MSB and end at the LSB, and the content may be given as shown in Table 5.

TABLE 5

| | Number |
|---|---|
| RAR UL grant field | of bits |
| Frequency hopping flag | 1 |
| Msg3 PUSCH frequency resource allocation | 12 |
| Msg3 PUSCH time resource allocation | 4 |
| Modulation and coding scheme (MCS) | 4 |
| Transmit power control (TPC) for Msg3 | 3 |
| PUSCH | |
| CSI request | 1 |

A TPC command is used to determine the transmission power of the Msg3 PUSCH. For example, the TPC command may be interpreted as shown in Table 6.

TABLE 6

| TPC command | Value [dB] |
|---|---|
| 0 | −6 |
| 1 | −4 |
| 2 | −2 |
| 3 | 0 |
| 4 | 2 |
| 5 | 4 |
| 6 | 6 |
| 7 | 8 |

(2) 2-Step RACH: Type-2 Random Access Procedure

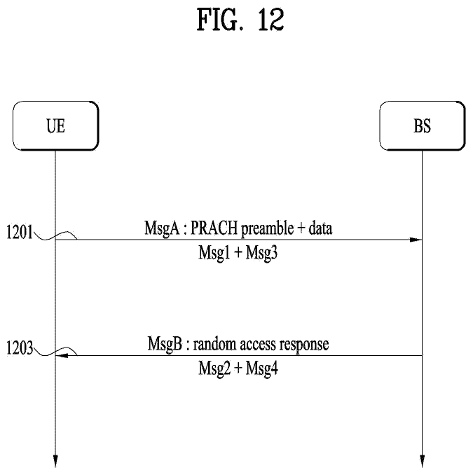

FIG. 12 is a diagram illustrating an exemplary 2-step RACH procedure.

The 2-step RACH procedure in which the (contention-based) RACH procedure is performed in two steps has been proposed to simplify the RACH procedure, that is, to achieve low signaling overhead and low latency.

The operations of transmitting Msg1 and Msg3 in the 4-step RACH procedure may be performed as one operation in the 2-step RACH procedure where the UE transmits one message (message A (MsgA)) including a PRACH and a PUSCH. The operations in which the BS transmits Msg2 and Msg4 in the 4-step RACH procedure may be performed as one operation in the 2-step RACH procedure where the BS transmits one message (message B (MsgB)) including an RAR and contention resolution information.

That is, in the 2-step RACH procedure, the UE may combine Msg1 and Msg3 of the 4-step RACH procedure into one message (e.g., MsgA) and transmit the one message to the BS (1201).

In addition, in the 2-step RACH procedure, the BS may combine Msg2 and Msg4 of the 4-step RACH procedure into one message (e.g., MsgB) and transmit the one message to the UE (S1203).

Based on the combination of these messages, the 2-step RACH procedure may provide a low-latency RACH procedure.

Specifically, MsgA of the 2-step RACH procedure may include a PRACH preamble contained in Msg1 and data contained in Msg3. MsgB of the 2-step RACH procedure may include an RAR contained in Msg2 and contention resolution information contained in Msg4.

(3) Contention-Free RACH

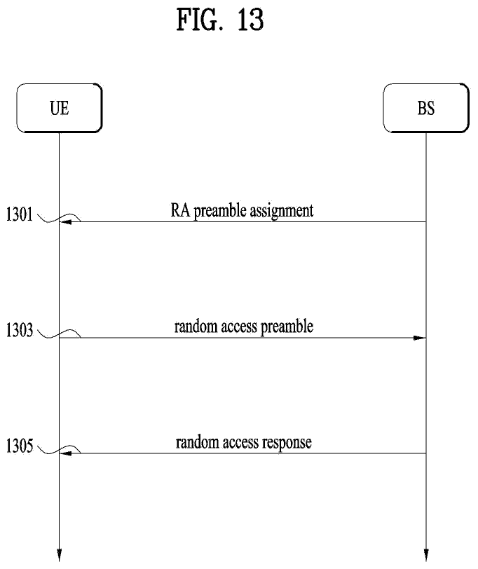

FIG. 13 is a diagram illustrating an exemplary contention-free RACH procedure.

The contention-free RACH procedure may be used when the UE is handed over to another cell or BS or when requested by a command from the BS. The basic steps of the contention-free RACH procedure are similar to those of the contention-based RACH procedure. However, in the contention-free RACH procedure, the BS allocates a preamble to be used by the UE (hereinafter, dedicated random access preamble) to the UE (1301), unlike the contention-based RACH procedure in which the UE arbitrarily selects a preamble to be used from among a plurality of random access preambles. Information on the dedicated random access preamble may be included in an RRC message (e.g., handover command) or provided to the UE through a PDCCH order. When the RACH procedure is initiated, the UE transmits the dedicated random access preamble to the BS (1303). When the UE receives an RAR from the BS, the RACH procedure is completed (1305).

In the contention-free RACH procedure, a CSI request field in an RAR UL grant indicates whether the UE includes an aperiodic CSI report in corresponding PUSCH transmission. The SCS for Msg3 PUSCH transmission is provided by an RRC parameter. The UE may transmit a PRACH and a Msg3 PUSCH on the same UL carrier of the same serving cell. The UL BWP for Msg3 PUSCH transmission is indicated by system information block 1 (SIB1).

(4) Mapping Between SSBs and PRACH Resources (Occasions)

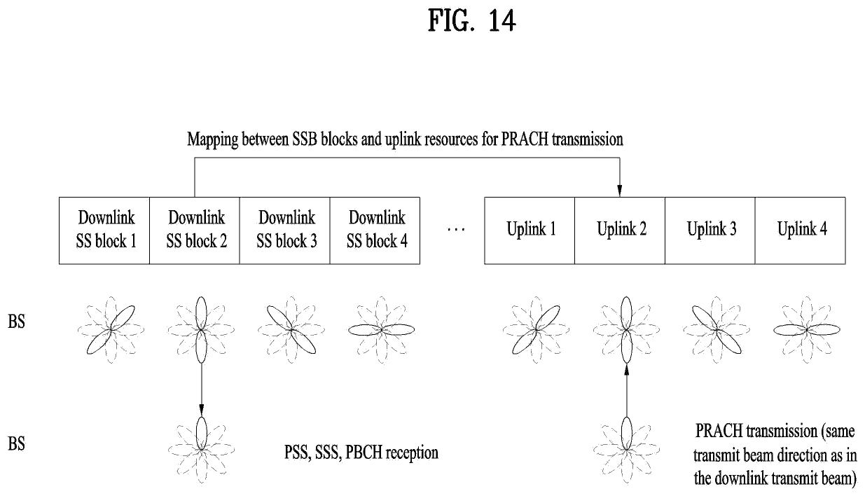

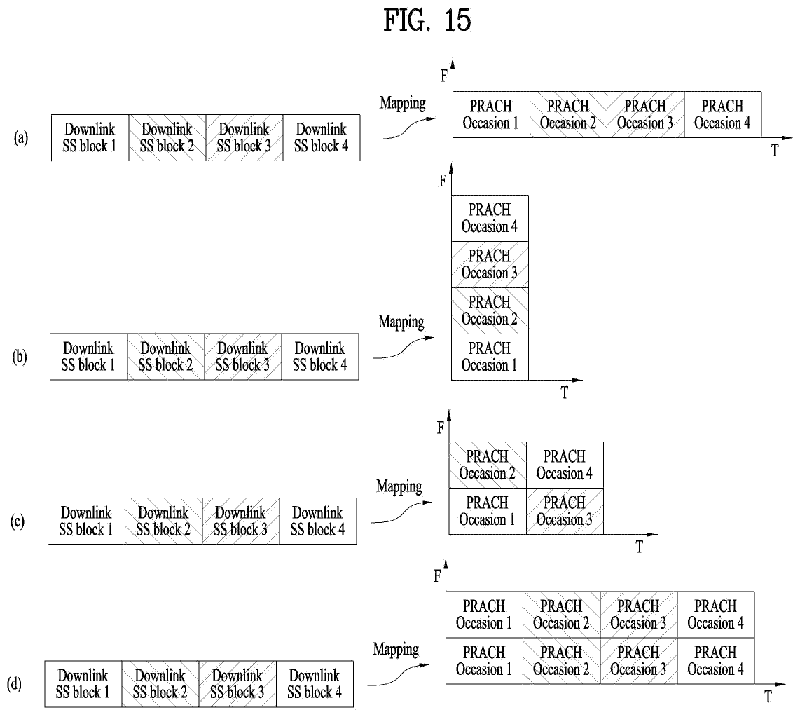

FIGS. 14 and 15 are diagrams illustrating transmission of SSBs and PRACH resources linked to the SSBs according to various embodiments of the present disclosure.

To communicate with one UE, the BS may need to find out what is the optimal beam direction between the BS and UE. Since it is expected that the optimal beam direction will vary according to the movement of the UE, the BS needs to continuously track the optimal beam direction. A process of finding out the optimal beam direction between the BS and UE is called a beam acquisition process, and a process of continuously tracking the optimal beam direction between the BS and UE is called a beam tracking process. The beam acquisition process may be required in the following cases: 1) initial access where the UE attempts to access the BS for the first time; 2) handover where the UE is handed over from one BS to another BS; and 3) beam recovery for recovering beam failure. The beam failure means a state in which while performing the beam tracking to find out the optimal beam between the UE and BS, the UE loses the optimal beam and thus is incapable of maintaining the optimal communication state with the BS or incapable of communicating with the BS.

In the NR system, a multi-stage beam acquisition process is being discussed for beam acquisition in an environment using multiple beams. In the multi-stage beam acquisition process, the BS and UE perform a connection setup by using a wide beam in the initial access stage. After the connection setup is completed, the BS and UE perform the highest quality of communication by using a narrow beam. The beam acquisition process in the NR system applicable to various embodiments of the present disclosure may be performed as follows.
1) The BS transmits a synchronization block for each wide beam to allow the UE to discover the BS in the initial access stage, that is, in order for the UE to find the optimal wide beam to be used in the first stage of the beam acquisition by performing cell search or cell acquisition and measuring the channel quality of each wide beam.
2) The UE performs the cell search on the synchronization block for each beam and acquires a DL beam based on the detection result for each beam.
3) The UE performs a RACH procedure to inform the BS that the UE discovers that the UE intends to access the BS.
4) The BS connects or associates the synchronization block transmitted for each beam with a PRACH resource to be used for PRACH transmission to allow the UE to simultaneously inform the RACH procedure and the DL beam acquisition result (e.g., beam index) at wide beam levels. If the UE performs the RACH procedure on a PRACH resource associated with the optimal beam direction that the UE finds, the BS obtains information on the DL beam suitable for the UE by receiving a PRACH preamble.

In the multi-beam environment, it is a problem whether the UE and/or TRP is capable of accurately determining the directions of a transmission (TX) and/or reception (RX) beam between the UE and TRP. In the multi-beam environment, repetition of signal transmission or beam sweeping for signal reception may be considered based on the TX/RX reciprocal capability of the TRP (e.g., BS) or UE. The TX/RX reciprocal capability of the TRP and UE is also referred to as TX/RX beam correspondence of the TRP and UE. In the multi-beam environment, if the TX/RX reciprocal capability of the TRP and UE is not valid (that is, not held), the UE may not be capable of transmitting a UL signal in the beam direction in which the UE receives a DL signals. This is because the UL optimal path may be different from the DL optimal path. The TX/RX beam correspondence of the TRP may be valid (held) if the TRP is capable of determining a TRP RX beam for UL reception based on DL measurements measured by the UE for one or more TX beams of the TRP and/or if the TRP is capable of determining a TRP TX beam for DL transmission based on UL measurements measured by the TRP for one or more RX beams of the TRP. The TX/RX beam correspondence of the UE may be valid (held) if the UE is capable of determining a UE RX beam for UL transmission based on DL measurements measured by the UE for one or more RX beams of the UE and/or if the UE is capable of determining a UE TX beam for DL reception based on an indication from the TRP, which is related to UL measurements for one or more TX beams of the UE.

(5) PRACH Preamble Structure

In the NR system, a RACH signal used for initial access to the B S, that is, initial access to the BS through a cell used by the BS may be configured based on the following elements.
Cyclic prefix (CP): The CP serves to prevent interference from previous (OFDM) symbols and bundle PRACH preamble signals arriving at the BS with various time delays in one same time zone. That is, if the CP is configured to match the maximum radius of a cell, PRACH preambles transmitted by UEs in the cell on the same resource may be within a PRACH reception window having a PRACH preamble length configured by the BS for PRACH reception. The length of the CP is generally set greater than or equal to the maximum round trip delay. The CP may have a length of TCP.
Preamble (sequence): A sequence may be defined for the BS to detect signal transmission, and the preamble serves to carry this sequence. The preamble sequence may have a length of TSEQ.
Guard time (GT): The GT is a time duration defined to prevent a PRACH signal that is transmitted from the point farthest from the BS in PRACH coverage and received by the BS with a delay from interfering with a signal that is received after a PRACH symbol duration. Since the UE transmits no signal in the GT period, the GT may not be defined as a PRACH signal. The GT may have a length of TGP.

(6) Mapping to Physical Resources for Physical Random-Access Channel

Random access preambles may be transmitted only on time resources obtained based on predetermined tables (RACH configuration tables) for RACH configurations, frequency range 1 (FR1), frequency range 2 (FR2), and predetermined spectrum types.

The PRACH configuration index in RACH configuration tables may be given as follows.
For a RACH configuration table for random access configurations for FR1 and unpaired spectrum, the PRACH configuration index may be given by a higher layer parameter prach-ConfigurationIndexNew (if configured). Otherwise, the PRACH configuration index may be given by prach-ConfigurationIndex, msgA-prach-ConfigurationIndex, or msgA-prach-ConfigurationIndexNew (if configured).
For a RACH configuration table for random access configurations for FR1 and paired spectrum/supplementary uplink and a RACH configuration table for random access configurations for FR2 and unpaired spectrum, the PRACH configuration index may be given by a higher layer parameter prach-ConfigurationIndex or msgA-prach-ConfigurationIndexNew (if configured).

For each case, the RACH configuration table may show relationships between one or more of the following parameters: PRACH configuration index, preamble format, nSFN mod x=y, subframe number, starting symbol, number of PRACH slots, number of time-domain PRACH occasions within a PRACH slot, and PRACH duration.

Each case may be:
(1) Random access configurations for FR1 and paired spectrum/supplementary uplink;
(2) Random access configurations for FR1 and unpaired spectrum; or
(3) Random access configurations for FR2 and unpaired spectrum.

Table 7 below shows a part of the RACH configuration table for (2) random access configurations for FR1 and unpaired spectrum.

TABLE 7

| | | | | | | | Nₜ^{RA, slot}, | |
|---|---|---|---|---|---|---|---|---|
| | | | | | | Number of | number of time- | |
| PRACH | | n_{SFN}mo | | | | PRACH slots | domain PRACH | N_{dur}^{RA}, |
| Configuration | Preamble | d x = y | | Subframe | Starting | within a | occasions within a | PRACH |
| Index | format | x | y | number | symbol | subframe | PRACH slot | duration |
| 0 | 0 | 16 | 1 | 9 | 0 | — | — | 0 |
| 1 | 0 | 8 | 1 | 9 | 0 | — | — | 0 |
| 2 | 0 | 4 | 1 | 9 | 0 | — | — | 0 |
| 3 | 0 | 2 | 0 | 9 | 0 | — | — | 0 |
| 4 | 0 | 2 | 1 | 9 | 0 | — | — | 0 |
| 5 | 0 | 2 | 0 | 4 | 0 | — | — | 0 |
| 6 | 0 | 2 | 1 | 4 | 0 | — | — | 0 |
| 7 | 0 | 1 | 0 | 9 | 0 | — | — | 0 |
| 8 | 0 | 1 | 0 | 8 | 0 | — | — | 0 |
| 9 | 0 | 1 | 0 | 7 | 0 | — | — | 0 |

The RACH configuration table shows specific values for parameters (e.g., preamble format, periodicity, SFN offset, RACH subframe/slot index, starting OFDM symbol, number of RACH slots, number of occasions, OFDM symbols for RACH format, etc.) required to configure RACH occasions. When the RACH configuration index is indicated, specific values related to the indicated index may be used.

For example, when the starting OFDM symbol parameter is n, one or more consecutive (time-domain) RACH occasions may be configured from an OFDM symbol having index #n.

For example, the number of one or more RACH occasions may be indicated by the following parameter: number of time-domain PRACH occasions within a RACH slot.

For example, a RACH slot may include one or more RACH occasions.

For example, the number of RACH slots (in a subframe and/or slot with a specific SCS) may be indicated by the parameter: number of RACH slots.

For example, a system frame number (SFN) including RACH occasions may be determined by nSFN mod x=y, where mod is a modular operation (modulo arithmetic or modulo operation) which is an operation to obtain remainder r obtained by dividing dividend q by divisor d (r=q mod (d)).

For example, a subframe/slot (index) including RACH occasions in a system frame may be indicated by the parameter: RACH subframe/slot index.

For example, a preamble format for RACH transmission/reception may be indicated by the parameter: preamble format.

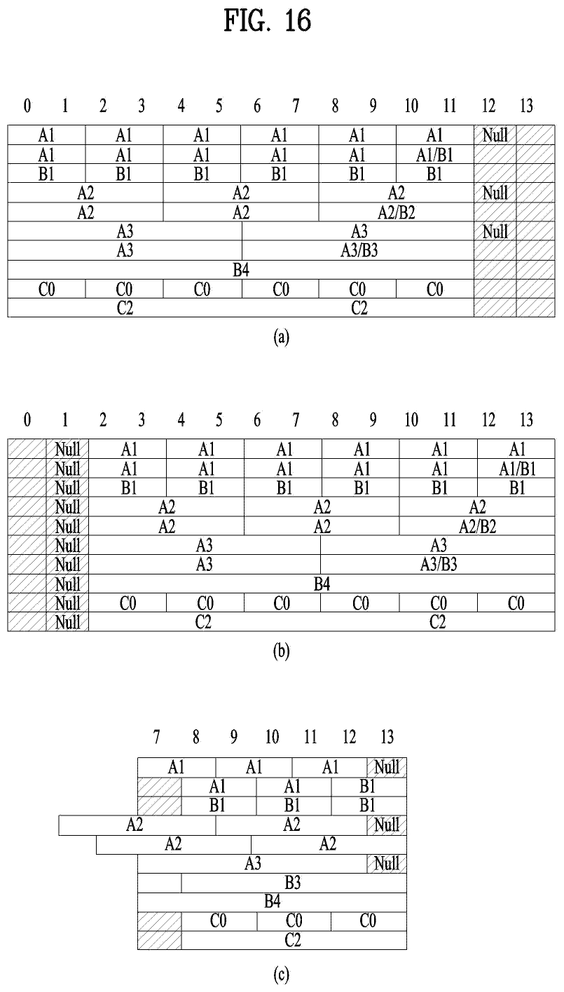

Referring to FIG. 16(a), for example, when the starting OFDM symbol is indicated as 0, one or more consecutive (time-domain) RACH occasions may be configured from OFDM symbol #0. For example, the number of one or more RACH occasions may depend on a value indicated by the parameter: number of time-domain RACH occasions within a RACH slot. For example, the preamble format may be indicated by the parameter: preamble format. For example, preamble formats A1, A2, A3, B4, C0, C2, etc. may be indicated. For example, one of the last two OFDM symbols may be used as the GT, and the other may be used for transmission of other UL signals such as a PUCCH, a sounding reference signal (SRS), etc.

Referring to FIG. 16(b), for example, when the starting OFDM symbol is indicated by 2, one or more consecutive (time-domain) RACH occasions may be configured from OFDM symbol #2. For example, 12 OFDM symbols may be used for a RACH occasion, and no GT may be configured in the last OFDM symbol. For example, the number of one or more RACH occasions may depend on a value indicated by the parameter: number of time-domain RACH occasions within a RACH slot. For example, the preamble format may be indicated by the parameter: preamble format. For example, preamble formats A1/B1, B1, A2/B2, A3/B3, B4, C0, C2, etc. may be indicated.

Referring to FIG. 16(c), for example, when the starting OFDM symbol is indicated as 7, one or more consecutive (time-domain) RACH occasions may be configured from OFDM symbol #7. For example, 6 OFDM symbols may be used for an RACH occasion, and the last OFDM symbol (OFDM symbol #13) may be used for transmission of other UL signals such as a PUCCH, an SRS, etc. For example, the number of one or more RACH occasions may depend on a value indicated by the parameter: number of time-domain RACH occasions within a RACH slot. For example, the preamble format may be indicated by the parameter: preamble format. For example, preamble formats A1, B1, A2, A3, B3, B4, C0, C2, etc. may be indicated.

For example, the parameters included in the RACH configuration table may satisfy predetermined correspondence relationships identified/determined by the RACH configuration table and the RACH configuration index. For example, the predetermined correspondence relationships may be satisfied between the following parameters: PRACH configuration index, RACH format, period (x)=8, SFN offset (y), subframe number, starting symbol (index), number of PRACH slots within a subframe, number of PRACH occasions within a PRACH slot, PRACH duration/OFDM symbols for RACH format, etc. The correspondence relationships may be identified by the RACH configuration index and the RACH configuration table.

Reduced Capability (RedCap)

The flexibility and expandability of 5G NR expand a 5G ecosystem and enable more and more devices to connect to a network in order to solve new use cases. To this end, in an NR system, support of a RedCap device is under discussion. The introduction of the NR RedCap device may expand an ecosystem of the NR system based on use cases described below.

Use Cases

Use cases of NR RedCap may include wearable devices (e.g., smartwatches, wearable medical devices, and AR/VR goggles), industrial wireless sensors, and video surveillance devices. [Table 8] below lists detailed use cases of RedCap.

TABLE 8

| | | | Avail- | | |
|---|---|---|---|---|---|
| | Data | | ability/ | Battery | Device |
| | Rate | Latency | Reliability | LifeTime | Size |
| Wearable | Reference | Relaxed | N/A | At least | Compact |
| | data rate: | | | several | form |
| | 5-50 | | | days and | factor |
| | Mbps in | | | up to | |
| | downlink | | | 1-2 | |
| | and 2-5 | | | weeks | |
| | Mbps in | | | | |
| | uplink | | | | |
| Industrial | <2 Mbps | <100 | 99.99% | At least | N/A |
| wireless | | ms | | a few | |
| sensors | | | | years | |
| Video | 2-4 Mbps for | <500 | 99%-99.9% | N/A | N/A |
| surveil- | economic | ms | | | |
| lance | video and | | | | |
| | 7.5-25 Mbps | | | | |
| | for high- | | | | |
| | end video | | | | |

Referring to Table 8, three use cases have lower requirements in terms of data rate and latency than eMBB use cases.

On the other hand, RedCap use cases have significantly different requirements from low-power wide-area (LPWA) use cases in current long-term evolution machine (LTE-M) and narrowband IoT (NB-IoT) solutions. For example, the data rate of RedCap may be higher than that of LPWA. In addition, there may be restrictions on a device form factor for a specific wearable use case. In other words, it is considered that a RedCap device will have a segment which is lower than eMBB and higher than an LPWA device.

RedCap Device Capability

[Table 9] shows comparison of the capability of an NR Rel 15 device with that of a RedCap device. Reducing bandwidth, reducing the maximum number of MIMO layers, and mitigating a maximum downlink modulation order may all aid in reducing baseband complexity.

TABLE 9

| | FR1 | | FR2 | |
|---|---|---|---|---|
| | Rel 15 | RedCap | Rel 15 | RedCap |
| | Device | Device | Device | Device |
| Maximum | 100 MHz | 20 MHz | 200 MHz | 100 MHz |
| device | | | | |
| Bandwidth | | | | |
| Minimum | 2 or 4, | 1 for bands | 2 | 1 |
| number of | depending | where a | | |
| device | on the | baseline NR | | |
| receive | frequency | device is | | |
| branches | band | required to | | |
| | | have 2 | | |
| | | TBD: 1 or 2 for | | |
| | | bands where a | | |
| | | baseline NR | | |
| | | device is | | |
| | | required to | | |
| | | have 4 | | |
| Maximum | 2 or 4, | 1 for RedCap | 2 | 1 |
| number of | depending | device with 1 | | |
| downlink | on the | Rx branch | | |
| MIMO | frequency | 2 for RedCap | | |
| layers | band | device with 2 | | |
| | | Rx branches | | |
| Maximum | 256 QAM | 64 QAM | 64 QAM | 64 QAM |
| downlink | | | | |
| modulation | | | | |
| order | | | | |
| Duplex | FD-FDD, | UE may | TDD | TDD |
| operation | TDD | implement | | |
| | | HD-FDD, FD- | | |
| | | FDD, TDD | | |

In an Rel-17 NR system, research on the RedCap device is underway. A RedCap UE may be configured to have higher requirements than a legacy LPWA (i.e., LTE-M/NB IoT) UE and lower requirements than a URLLC/eMBB UE. Meanwhile, a maximum of 1 Rx Branch or a maximum of 2 Rx Branches may be configured for the RedCap UE. In this case, the maximum number of Rx Branches configured for the RedCap UE may be obtained through an RRC parameter called maxNumberMIMO-LayersPDSCH. In other words, if the number of MIMO layers is notified (or signaled) to the RedCap UE through the maxNumberMIMO-LayersPDSCH parameter, the number of Rx branches of the RedCap UE can be indirectly recognized based on the resultant number of MIMO layers.

On the other hand, at the RAN1 #101-e conference, UE bandwidth reduction for a RedCap UE has been discussed, and it was determined for an initial bandwidth for initial access in FR1 to support a maximum of 20 MHz.

However, in the case of the maximum initial BW of 20 MHz of the RedCap UE, some of the RACH occasion (RO) configurations supported by the current NR standard may not be supported. Therefore, the present disclosure relates to a method for selecting an optimal SSB associated with the ROs when ROs exceeding the maximum initial BW of the RedCap UE are configured, and as such a detailed description thereof will hereinafter be given.

A UE (legacy UE) operating in a Rel-15 or Rel-16 NR system can preferentially acquire a master information block (MIB) through a synchronization signal block (SSB) to be broadcast prior to performing a random access procedure through a network. In the NR system, the SSB is set to 20 resource blocks (RBs) regardless of SCS (Subcarrier Spacing), and the SSB of the legacy NR system can also be equally utilized even in RedCap.

The MIB may include control information for CORESET #0 scheduling SIB1 (System Information Block 1). In addition, SIB1 may include basic information for random access. Among the above control information and basic information, up to 8 ROs in which the UE can transmit the PRACH preamble can be configured based on FDM. ⅛ SSB, ¼ SSB, ½ SSB, 1 SSB, 2 SSBs, 4 SSBs, 8 SSBs, and/or 16 SSBs can be mapped to one RO. A maximum of L SSBs (e.g., a maximum of 8 SSBs in FR1 or a maximum of 64 SSBs in FR2) can be transmitted within an SSB burst set. At this time, since up to L SSBs are transmitted through different beams, SSB reception is related to the initial DL beam of the UE.

Therefore, the UE may inform the network of the best SSB (best DL beam) by transmitting the PRACH preamble through the RO associated with the best SSB (or best DL beam). Among the formats in which the PRACH preamble can be configured, the short preamble in each of the long preamble format 3 and the 30 kHz SCS is 4.32 MHz. Thus, when 8 ROs are FDM-configured, 34.56 MHz exceeding the maximum initial BW of 20 MHz of the RedCap UE can be obtained. As a result, when 8 ROs are FDM-configured, only up to 4 ROs can be supported within the 20 MHz BW of the RedCap UE, and thus PRACH preamble transmission through ROs not included in the 20 MHz BW may be impossible. As a result, the RedCap UE may not select the best SSB in the initial access process.

The present disclosure proposes a method for solving the above-described problem. Proposed in the present disclosure are a method for allowing the RedCap UE to select an initial UL BWP by a RedCap UE, a method for allowing the RedCap UE to select the best SSB through preamble index classification, a method for allowing the RedCap UE to select the 1^{st} or 2^{nd} best SSB through a restricted RO, and the like.

In the present disclosure, it is assumed that the initial UL BWP is configured in SIB1 that was shared with the legacy UE by the RedCap UE or given separately. The legacy UE may be configured to transmit a short preamble PRACH in the long preamble format 3 or the 30 kHz SCS to 8 FDMed ROs. It is assumed that the SSB is transmitted through 8 beams and one SSB is mapped to one RO. However, the embodiments of the present disclosure can also be equally applied to the case in which less than 8 SSBs are configured and two or more SSBs are mapped to one RO without departing from the scope or spirit of the present disclosure.

The initial UL BWP of the RedCap UE may be smaller than the initial BWP of the legacy UE. In addition, the initial UL BWP of the RedCap UE may be configured to completely or partially overlap the initial BWP of the legacy UE. In other words, the RedCap UE and the legacy UE may share one or more ROs that transmit the PRACH preamble in the initial UL BWP. The RedCap UE may completely share each RO with the legacy UE, and up to 4 ROs can be allocated to the RedCap UE due to the size limit of the maximum initial UL BWP. Information as to whether a PRACH was transmitted by the RedCap UE or by the legacy UE can be identified through a PRACH preamble index or the like. The method proposed in the present disclosure can be applied not only to the case in which the initial UL BWP of the RedCap UE is configured to be smaller than the initial UL BWP of the legacy UE, but also to the case in which the initial UL BWP of the RedCap UE completely or partially overlaps the initial UL BWP of the legacy UE. In addition, although the present disclosure has disclosed the example case in which one SSB is mapped to one RO for convenience of description, the present disclosure can be extended and applied as long as the spirit of the present disclosure is maintained. That is, the present disclosure can be applied not only to the case where the SSB-to-RO mapping is 1:1 mapping, but also to the other case where the SSB-to-RO mapping is many-to-one mapping or one-to-many mapping.

Details of the PRACH Preamble format are described in detail in 3GPP Rel-15 and Rel-16 standard documents (e.g., 3GPP TS 38.211 V16.2.0), and the present specification includes 3GPP Rel-15 and Rel-16 standard documents as a reference. For example, according to the present disclosure, the long preamble may refer to a PRACH preamble format according to Table 6.3.3.1-1 of 3GPP TS 38.211 V16.2.0, and the long preamble format 3 may refer to a PRACH preamble format according to Format 3 of Table 6.3.3.1-1. In addition, according to the present disclosure, the short preamble may refer to one of the PRACH preamble formats (e.g., format A1, A2, A3, B1, B2, B3, B4, C0, C2) according to Table 6.3.3.1-2 of 3GPP TS 38.211 V16.2.0. The long preamble format may be simply referred to as a long format, and a short preamble format may be simply referred to as a short format.

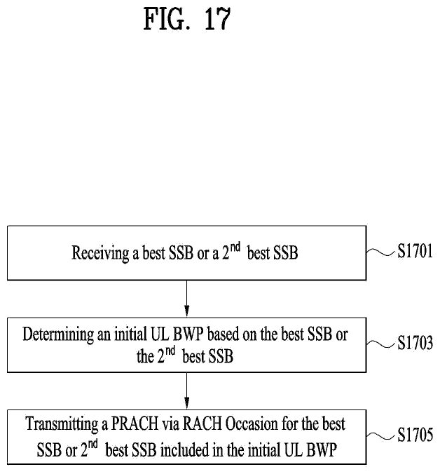

FIGS. 17 to 19 are flowcharts illustrating overall operation processes of the UE, the BS, and the network according to the methods of the present disclosure.

FIG. 17 is a flowchart illustrating an overall operation process of the UE according to methods of the present disclosure.

Referring to FIG. 17, the UE may receive and measure the best SSB or the 2^{nd} best SSB among one or more SSBs (S1701). In addition, the UE may determine the initial UL BWP according to Method 1-1 and/or Method 1-2 of Method 1 based on the best SSB or the 2^{nd} best SSB (S1703). Meanwhile, the best SSB may refer to an SSB having the highest Received Signal Strength Indicator (RSSI) and/or the highest Reference Signal Received Power (RSRP) among one or more SSBs received by the UE. Also, the 2^{nd} best SSB may refer to an SSB having a second highest Received Signal Strength Indicator (RSSI) and/or a second highest Reference Signal Received Power (RSRP) among at least one SSB received by the UE.

In addition, the UE may transmit the PRACH preamble through an RO mapped to the best SSB or the 2^{nd} best SSB from among ROs included in the initial UL BWP (S1705). In this case, a method for mapping the best SSB or the 2^{nd} best SSB to the RO may be configured based on Method 2 and Method 3. In addition, a method for distinguishing the best SSB or the 2^{nd} best SSB may be configured based on Method 3-1 and/or Method 3-2.

In addition, when the operation of FIG. 17 is performed in FR1, the operation of FIG. 17 can be based on Methods 1 to 3-2, but Method 4 can also be additionally considered when the operation of FIG. 17 is performed in FR2.

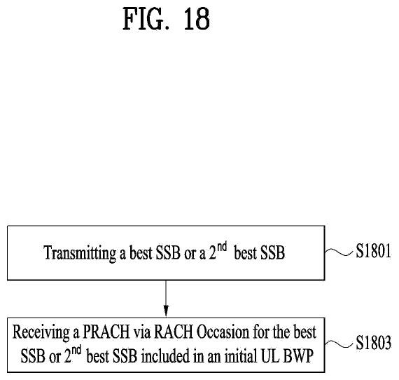

FIG. 18 is a flowchart illustrating overall operation processes of the base station (BS) according to methods of the present disclosure.

Referring to FIG. 18, the base station (BS) may transmit at least one SSB (S1801). In addition, the BS may receive the PRACH Preamble through an RO mapped to the best SSB or 2^{nd} best SSB measured by the UE from among the ROs included in the initial UL BWP (S1803). In this case, the initial UL BWP may be determined according to Method 1-1 and/or Method 1-2 of Method 1. In addition, the method for mapping either the best SSB or the 2^{nd} best SSB to RO may be configured based on Method 2 and Method 3. In addition, a method for allowing the BS to distinguish whether the received PRACH preamble was transmitted by the legacy UE or the RedCap UE may be configured based on Method 3-1 and/or Method 3-2. Meanwhile, the best SSB may refer to an SSB having either the highest RSSI (Received Signal Strength Indicator) and/or the highest RSRP (Reference Signal Received Power) among at least one SSB received by the UE. Also, the 2^{nd} best SSB may refer to an SSB having either the second highest RSSI and/or the second highest RSRP among at least one SSB received by the UE.

In addition, when the operation of FIG. 18 is performed in FR1, the operation of FIG. 18 can be configured based on Method 1 to Method 3-2, but when the operation of FIG. 18 is performed in FR2, Method 4 can be additionally considered.

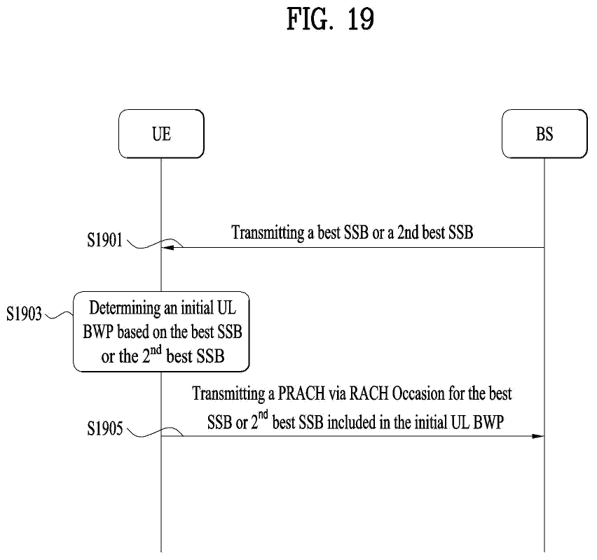

FIG. 19 is a flowchart illustrating overall operation processes of the network according to methods of the present disclosure.

Referring to FIG. 19, the BS may transmit at least one SSB (S1901). The UE may measure the best SSB or the 2^{nd} best SSB among at least one SSB. In addition, the UE may determine the initial UL BWP according to Method 1-1 and/or Method 1-2 of Method 1 based on the best SSB or the 2^{nd} best SSB (S1903). Meanwhile, the best SSB may refer to an SSB having the highest RSSI and/or the highest RSRP among at least one SSB received by the UE. Also, the 2^{nd} best SSB may refer to an SSB having the second highest RSSI and/or the second highest RSRP among at least one SSB received by the UE.

In addition, the UE may transmit the PRACH Preamble through an RO mapped to the best SSB or the 2^{nd} best SSB among ROs included in the initial UL BWP (S1905). In this case, a method for mapping the best SSB or the 2^{nd} best SSB to RO may be configured based on Method 2 and Method 3. In addition, a method for distinguishing the best SSB or the 2^{nd} best SSB from each other may be configured based on Method 3-1 and/or Method 3-2.

In addition, when the operation of FIG. 19 is performed in FR1, the operation of FIG. 19 can be configured based on Method 1 to Method 3-2, but when the operation of FIG. 19 is performed in FR2, Method 4 can be additionally considered.

[Method 1]

The initial UL BWP of the RedCap UE may be configured based on the RO selected to transmit the PRACH preamble.

When the NR legacy UE transmits a PRACH preamble based on long format 3 or short format at 30 kHz through 8 FDMed ROs, a maximum of four RedCap UEs can be configured. According to Method 1, according to the RO to be selected by the RedCap UE, the BWP capable of including the corresponding RO can be set to the initial UL BWP.

1. Method 1-1

According to Method 1-1, one of a plurality of BWPs classified in units of 20 MHz based on the best SSB may be set to the initial UL BWP so that the initial UL BWP is then allocated to the RedCap UE.

In the NR system of Rel-15 and Rel-16, ROs can be indexed in order from a low frequency region to a high frequency region, and a maximum of eight ROs from 0 to 7 can be indexed. In addition, the RedCap UE may transmit a PRACH preamble through the RO mapped to the best SSB.

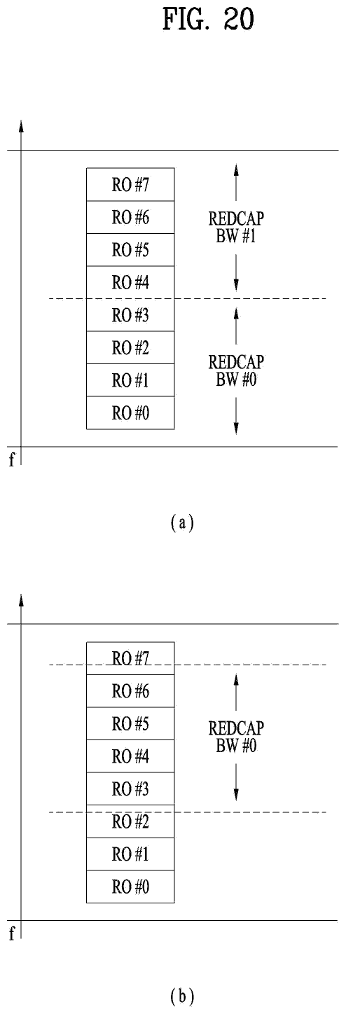

Meanwhile, when the initial UL BWP of the legacy UE is set to 40 MHz, a lower 20 MHz and a higher 20 MHz can be respectively set to the initial UL BWP index #0 and the initial UL BWP index #1 for the RedCap UE as shown in FIG. 20(a). As for the eight FDMed ROs, ROs #0, #1 , #2, and #3 may be included in the initial UL BWP index #0 of the RedCap UE, and ROs #4, #5 , #6, and #7 may be included in the initial UL BWP index #1. The RedCap UE may transmit the PRACH preamble through the RO mapped to the best SSB, and the UL BWP corresponding to the BWP index including the corresponding RO may be set to the initial UL BWP of the RedCap UE and then allocated to the RedCap UE. For example, if the RO mapped to the best SSB is RO #5, the initial UL BWP index #1 may be configured as an initial UL BWP for the RedCap UE.

Meanwhile, as shown in FIG. 20(a), CORESET #0 may be individually or identically configured for each initial UL BWP index. If CORESET #0 need not be individually set for each initial UL BWP, CORESET #0 of one BWP index can be configured, and the corresponding CORESET #0 can be copied for the remaining BWP indexes.

For example, as shown in FIG. 20 (a), when CORESET #0 is set to the initial UL BWP #0, the time resources identical to those of the corresponding CORESET #0 may be configured for CORESET #0 of the initial UL BWP #1, and a frequency resource to which a predetermined offset is applied in the frequency resource for the initial UL BWP #0 may be configured for CORESET #0 of the initial UL BWP #1. In this case, a constant (predetermined) offset may indicate any one of the distance between the center (intermediate) frequency of the initial UL BWP #0 and the center frequency of the initial UL BWP #1, the distance between the lowest frequency position of the initial UL BWP #0 and the lowest frequency position of the initial UL BWP #1, or the distance between the highest frequency position of the initial UL BWP #0 and the highest frequency position of the initial UL BWP #1.

On the other hand, when the initial UL BWP is fixed (e.g., initial UL BWP index #0) and the RedCap UE selects an RO included in another initial UL BWP index, BWP switching can be performed using another initial UL BWP corresponding to the corresponding RO. In this case, in consideration of the BWP switching time, if the initial UL BWP different from the initial UL BWP is set to FDD, the scheduling timer of Msg3 may start operation, and if the initial UL BWP is set to TDD, the RAR window may be started.

2. Method 1-2

According to Method 1-2, the initial UL BWP may be configured based on the RO mapped to the SSB selected by the RedCap UE.

The initial UL BWP may be configured based on the RO selected by the RedCap UE to transmit the PRACH preamble. FIG. 20(b) illustrates a non-limiting example in which the initial UL BWP is configured when a PRACH preamble is transmitted through RO #5. A configuration method in which the initial UL BWP of the RedCap UE fully overlaps the initial UL BWP of the legacy UE will hereinafter be described in detail.

(1) When the PRACH preamble is transmitted in RO #n having an index not corresponding to #0, #1, or #7, 10 MHz above and below based on the lowest point of the frequency range of RO #n is set to the initial UL BWP of the RedCap UE. Alternatively, when the PRACH preamble is transmitted in RO #n having an index not corresponding to #0, #6, or #7, 10 MHz above and below (a total of 20 MHz) based on the highest point of the frequency range of RO #n can be set to the initial UL BWP of the RedCap UE. Alternatively, if the PRACH preamble is transmitted in RO #n having an index not corresponding to #0, #1 , #6, or #7, 10 MHz above and below the center frequency of the frequency range of RO #n (a total of 20 MHz) can be set to the initial UL BWP of RedCap UE.

(2) When the PRACH preamble is transmitted in ROs #0 and #1, 10 MHz above and below the lowest point of the frequency range of RO #2 can be set to the initial UL BWP of the RedCap UE. Alternatively, when the PRACH preamble is transmitted in ROs #6 and #7, 10 MHz (a total of 20 MHz) above and below the highest point of the frequency range of RO #5 may be set to the initial UL BWP of the RedCap UE. Alternatively, 10 MHz (a total of 20 MHz) above and below the center frequency of the frequency range of RO #2 may be set to the initial UL BWP of the RedCap UE.

(3) When the PRACH preamble is transmitted in RO #7, 10 MHz (a total of 20 MHz) above and below the lowest point of the frequency range of RO #6 may be set to the initial UL BWP of the RedCap UE. Alternatively, when the PRACH preamble is transmitted in RO #0, 10 MHz (a total of 20 MHz) above and below the highest point of the frequency range of RO #1 may be set to the initial UL BWP of the RedCap UE. Alternatively, 10 MHz (a total of 20 MHz) above and below the center frequency of the frequency range of RO #5 may be set to the initial UL BWP of the RedCap UE.

When the initial UL BWP of the RedCap UE is set to partially overlap the initial UL BWP of the legacy UE, 10 MHz (total 20 MHz) above or below any one of the lowest point, the highest point, or the center point of the frequency range of RO #n to which the PRACH preamble is transmitted may be set to the initial UL BWP of the RedCap UE regardless of the indexes of the ROs.

[Method 2]

According to Method 2, the RedCap UE may transmit a PRACH preamble through an RO mapped to the best SSB (or the 2^{nd} best SSB) based on the RO-to-SSB mapping configuration.

The network may transmit the SSB based on beam-sweeping as shown in FIGS. 6 and 9. SSB beams of adjacent indexes may have similar directivity. Therefore, if the UE determines that SSB #n is the best SSB through measurement, SSB #n−1 or SSB #n+1 may become the 2^{nd} best SSB.

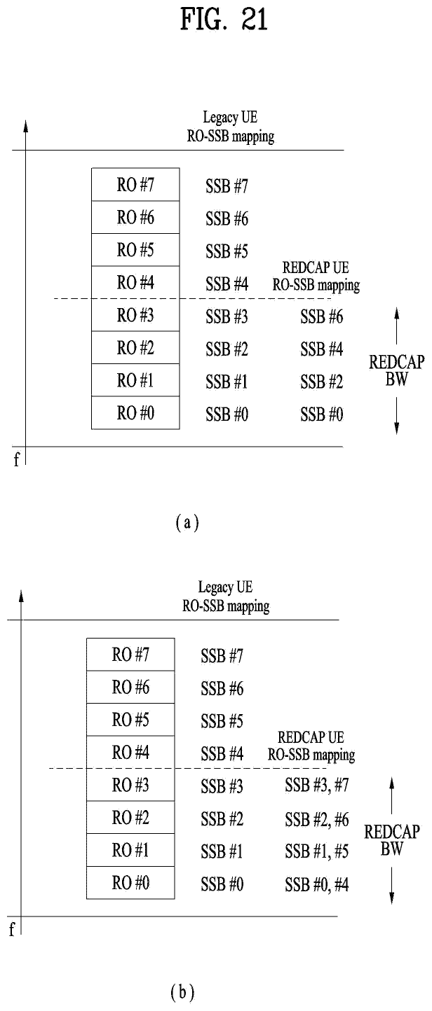

Therefore, the SSB mapped to the RO for the RedCap UE may increase in index in a two-by-two manner rather than in one-by-one manner in a similar way to the legacy UE. FIG. 21(a) illustrates, as a non-limiting example, RO-to-SSB mapping according to Method 2 of the present disclosure. Referring to FIG. 21(a), in order to reduce the number of cases in which the SSBs selected for the same one RO by the legacy UE and the RedCap UE are different from each other, SSBs #0, #2 , #4, and #6 can be respectively mapped to ROs #0, #1 , #2, and #3 for the RedCap UE. Various mapping methods can also be used as needed.

When the RedCap UE selects the 2^{nd} best SSB, the best beam can be changed to a serving beam through a beam refinement process to be described later. For example, referring to FIG. 21(a), when SSB #1 is the best SSB, there is no RO mapped to SSB #1. However, as described above, the 2^{nd} best SSB is more likely to be SSB #0 or SSB #2. Therefore, the PRACH Preamble may be transmitted through RO #0 or RO #1 corresponding to SSB #0 or SSB #2, which is the 2^{nd} best SSB, and then the beam corresponding to SSB #1 may be changed to a serving beam through a beam refinement process.

[Method 3]

For the RedCap UE, although the number of ROs for the RedCap UE is limited in a situation where the number of SSBs mapped to one RO is different from the number of SSBs mapped to the RO for the legacy UE, the best SSB can be selected as needed.

In a situation where RO-to-SSB mapping for the RedCap UE is set to be different from the RO-to-SSB mapping for the legacy UE, even in the case of the RedCap UE, all SSB beams can be mapped to the allocated RO.

For example, the number of SSBs mapped to the RO allocated to the initial UL BWP of the RedCap UE may be set to 2 so that all 8 SSBs may be mapped to 4 ROs.

FIG. 21(b) is a diagram of the non-limiting example in which 8 SSBs are mapped to 4 ROs when the initial UL BWP of the RedCap UE is configured to include ROs #0, #1 , #2, and #3. As can be seen from the example of FIG. 21(b), RO-to-SSB mapping of the legacy UE can maximally overlap with RO-to-SSB mapping of the RedCap UE, and other mapping methods are also possible.

Specifically, referring to FIG. 21(b), 4 ROs may be included in the initial UL BWP for the RedCap UE, and 8 SSBs may be sequentially mapped to the 4 ROs. That is, the ‘mod’ function can be used to map 8 SSBs to 4 ROs. For example, as shown in FIG. 21(b), SSB indexes having the same resultant value may be mapped to the same RO using the ‘mod’ function (SSB index, the number of ROs). In addition, sequential mapping from the RO having a low index (or the RO having a high index) to the RO having a high index (or the RO having a low index) can be performed in the order from the SSB indexes each having a low resultant value to the SSB indexes each having a high resultant value.

In other words, referring to FIG. 21(b), it is assumed that four ROs from RO #0 to RO #3 are included in the initial UL BWP for the RedCap UE and eight ROs from SSB #0 to SSB #7 are mapped to RO #0 to RO #3. Then, if ‘the mod’ (SSB index, 4) function is used, (SSB #0, SSB #4) having the same resultant value may constitute one pair, (SSB #1, SSB #5) having the same resultant value may constitute one pair, (SSB #2, SSB #6) having the same resultant value may constitute one pair, and (SSB #3, SSB #7) having the same resultant value may constitute one pair. In addition, (SSB #0, SSB #4) may be mapped to RO #0, (SSB #1, SSB #5) may be mapped to RO #1, (SSB #2, SSB #6) may be mapped to RO #2, and (SSB #3, SSB #7) may be mapped to RO #3.

1. Method 3-1

Meanwhile, it is possible to recognize the SSB selected by the RedCap UE through the PRACH preamble index.

Specifically, it can be determined whether the UE is the RedCap UE or the legacy UE through the RO based on the RACH configuration of the RedCap UE. If the RedCap UE is decided, the SSB selected by the RedCap UE can be distinguished based on the PRACH preamble index. That is, based on the RACH configuration of the RedCap UE, the SSB index received by the base station (BS) and the type of UE (e.g., RedCap UE or legacy UE) that has transmitted the corresponding SSB can be distinguished from each other using the RO and the PRACH preamble index.

For example, when the PRACH preamble indices for RO #0 are divided into three regions {A}, {B}, and {C}, there may be three cases as follows.

In a first case, a PRACH preamble index of the region {A} may allow the legacy UE to select SSB #0.

In a second case, a PRACH preamble index of the region {B} may allow the RedCap UE to select SSB #0.

In a third case, a PRACH preamble index of the region {C} may allow the RedCap UE to select SSB #4.

At this time, the meaning of dividing the PRACH preamble indices into three regions may indicate that, when the PRACH preamble indices for RO #0 are grouped into three groups from the first group to the third group and the BS receives the PRACH preamble index included in the first group, this means that the legacy UE has selected SSB #0, when the BS receives the PRACH preamble index included in the second group, this means the RedCap UE has selected SSB #0, and when the BS receives the PRACH preamble index included in the third group, this means that the RedCap UE has selected SSB #4.

That is, the network can distinguish the legacy UE and the RedCap UE from each other by checking the PRACH preamble index transmitted from the RO. Here, if the RedCap UE is decided, the network can schedule the RAR by distinguishing the SSB selected by the corresponding RedCap UE.

2. Method 3-2

Based on the reception of Msg3, the SSB selected by the RedCap UE may be recognized.

As shown in Method 3-2, when it is difficult to recognize the SSB selected by the corresponding UE and the type of UE that has transmitted the PRACH preamble through the PRACH preamble index based on the RACH configuration, the SSB selected by the RedCap UE based on Msg3 reception can be recognized. For example, when the RedCap UE transmits the PRACH preamble through RO #0, the network may alternately transmit the RAR for SSB #0 corresponding to RO #0 and the RAR for SSB #4. The RedCap UE may select one of two Msg3s scheduled in two RARs and then transmit the selected Msg3, such that the network can select the DL beam by recognizing the SSB selected by the RedCap UE.

[Method 4]

In FR1, the embodiments proposed in Methods 1 to 3 can be utilized appropriately for their purposes even when the RACH occasion that is capable of being configured in the UE instead of the RedCap UE exceeds the maximum initial BW (e.g., 20 MHz) for the RedCap UE.

In addition to the case where the maximum initial BW for the RedCap UE is 20 MHz, the embodiments proposed in Method 1 to Method 3 can be used to implement the purpose. For example, whereas the maximum initial BW for the RedCap UE in FR1 is set to 20 MHz in FR1, a larger BW may be used as the maximum initial BW for the RedCap UE in FR2. For example, in FR2, the maximum initial BW for the RedCap UE may be set to 100 MHz.

In this case, the embodiments proposed in Method 1 to Method 3 can be utilized to implement the purposes.

In addition, even when the maximum initial BW for the RedCap UE in FR2 exceeds 100 MHz, the embodiments proposed in Method 1 to Method 3 can be utilized to implement the purposes.

Meanwhile, although the above-described methods have been disclosed based on 30 kHz SCS to which the long preamble format 3 and the short preamble are applied for convenience of description, the scope or spirit of the present disclosure is not limited thereto, and it should be noted that the RACH occasion capable of being configured can exceed the maximum initial BW of the UE. Table 10 below shows an excerpt from 3GPP TS 38.211 (ver. 16.5).

TABLE 10

| | | | N_{RB}^{RA}, allocation | |
|---|---|---|---|---|
| | Δf_{RA} | Δf | expressed in | |
| | for | for | number of RBs | |
| L_{RA} | PRACH | PUSCH | for PUSCH | k̅ |
| 839 | 1.25 | 15 | 6 | 7 |
| 839 | 1.25 | 30 | 3 | 1 |
| 839 | 1.25 | 60 | 2 | 133 |
| 839 | 5 | 15 | 24 | 12 |
| 839 | 5 | 30 | 12 | 10 |
| 839 | 5 | 60 | 6 | 7 |
| 139 | 15 | 15 | 12 | 2 |
| 139 | 15 | 30 | 6 | 2 |
| 139 | 15 | 60 | 3 | 2 |
| 139 | 30 | 15 | 24 | 2 |
| 139 | 30 | 30 | 12 | 2 |
| 139 | 30 | 60 | 6 | 2 |
| 139 | 60 | 60 | 12 | 2 |
| 139 | 60 | 120 | 6 | 2 |
| 139 | 120 | 60 | 24 | 2 |
| 139 | 120 | 120 | 12 | 2 |
| 571 | 30 | 15 | 96 | 2 |
| 571 | 30 | 30 | 48 | 2 |
| 571 | 30 | 60 | 24 | 2 |
| 1151 | 15 | 15 | 96 | 1 |
| 1151 | 15 | 30 | 48 | 1 |
| 1151 | 15 | 60 | 24 | 1 |

Variables in the first row of Table 10 may refer to values, that are used for the number of RBs to which RACH occasion (expressed in the order of the length of the PRACH preamble SCS of PRACH→SCS of PUSCH→SCS of PUSCH) is allocated and are also used for signal generation. Through this, assuming that up to 8 FDMed ROs can be set, the frequency band to which the FDMed ROs are allocated can be calculated as shown in Table 11.

TABLE 11

| | | | N_{RB}^{RA}, | Frequency | Frequency |
|---|---|---|---|---|---|
| | | | allocation | band to which | band allocated |
| | | | expressed | one RO is | when 8 ROs |
| | Δf_{RA} | Δf | in number | actually | are FDM- |
| | for | for | of RBs for | allocated | processed |
| L_{RA} | PRACH | PUSCH | PUSCH | (kHz) | (MHz) |
| 839 | 1.25 | 15 | 6 | 1080 | 8.64 |
| 839 | 1.25 | 30 | 3 | 1080 | 8.64 |
| 839 | 1.25 | 60 | 2 | 1440 | 11.52 |
| 839 | 5 | 15 | 24 | 4320 | 34.56 |
| 839 | 5 | 30 | 12 | 4320 | 34.56 |
| 839 | 5 | 60 | 6 | 4320 | 34.56 |
| 139 | 15 | 15 | 12 | 2160 | 17.28 |
| 139 | 15 | 30 | 6 | 2160 | 17.28 |
| 139 | 15 | 60 | 3 | 2160 | 17.28 |
| 139 | 30 | 15 | 24 | 4320 | 34.56 |
| 139 | 30 | 30 | 12 | 4320 | 34.56 |
| 139 | 30 | 60 | 6 | 4320 | 34.56 |
| 139 | 60 | 60 | 12 | 8640 | 69.12 |
| 139 | 60 | 120 | 6 | 8640 | 69.12 |
| 139 | 120 | 60 | 24 | 17280 | 138.24 |
| 139 | 120 | 120 | 12 | 17280 | 138.24 |
| 571 | 30 | 15 | 96 | 17280 | 138.24 |
| 571 | 30 | 30 | 48 | 17280 | 138.24 |
| 571 | 30 | 60 | 24 | 17280 | 138.24 |
| 1151 | 15 | 15 | 96 | 17280 | 138.24 |
| 1151 | 15 | 30 | 48 | 17280 | 138.24 |
| 1151 | 15 | 60 | 24 | 17280 | 138.24 |

Referring to Table 11, not only the case in which the long format 3 and the short format of 30 kHz are used as described above, but also the other case in which a bandwidth exceeds a maximum bandwidth of the UE may occur. That is, in Table 11, when L_{RA} is set to 139 (L_{RA}=139) and SCS of PRACH is set to 120 kHz in a state in which L_{RA} is set to 139 (L_{RA}=139), and when L_{RA} is set to 571 and 1151 (L_{RA}=571 and 1151) in a state in which L_{RA} is set to 139 (L_{RA}=139), the bandwidth can exceed the maximum bandwidth of the UE.

Among the above-described cases, when L_{RA}=139 is decided, the resultant bandwidth exceeds 100 MHz corresponding to the maximum initial UL BWP of the RedCap UE in FR2. Therefore, even in this case, the above-described Method 1 to Method 3 can be utilized. For example, the maximum initial UL BWP described in Method 1 may be changed from 20 MHz to 100 MHz, so that the changed UL BWP can be applied to the above cases. Specifically, according to Method 1-1, the initial UL BWPs #0 and #1 for the RedCap UE may be set and applied in units of 100 MHz. In addition, the unit criterion used for setting the overlapping BWP in Method 1-2 may be applied in units of 50 MHz. In other words, when partial overlapping occurs in Method 1-2, 10 MHz or 50 MHz (total of 20 MHz or total of 100 MHz) above or below the lowest point (or the highest point) of the frequency range for RO #n may be set as the initial UL BWP of the RedCap UE.

On the other hand, when full overlapping occurs in Method 1-2, 10 MHz of Methods 1 to 3 of Method 1-2 can be changed to 50 MHz.

A detailed description thereof is as follows.

(1) When the PRACH preamble is transmitted in RO #n having an index not corresponding to #0, #1, or #7, 10 MHz or 50 MHz above and below based on the lowest point of the frequency range of RO #n (total of 20 MHz or 100 MHz) may be set as the initial UL BWP of the RedCap UE. Alternatively, if the PRACH preamble is transmitted in RO #n having an index not corresponding to #0, #6, or #7, 10 MHz or 50 MHz above and below the highest point of the frequency range of RO #n (total of 20 MHz or 100 MHz) may be set as the initial UL BWP of the RedCap UE. Alternatively, if the PRACH preamble is transmitted in RO #n having an index not corresponding to #0, #1 , #6, or #7, 10 MHz or 50 MHz above and below the center frequency of the frequency range of RO #n (total of 20 MHz or 100 MHz) may be configured as the initial UL BWP of the RedCap UE.

(2) When the PRACH preamble is transmitted in ROs #0 and #1, 10 MHz or 50 MHz (total of 20 MHz or 100 MHz) above and below based on the lowest point of the frequency range of RO #2 may be configured as the initial UL BWP of the RedCap UE. Alternatively, when the PRACH preamble is transmitted in ROs #6 and #7, 10 MHz or 50 MHz (total of 20 MHz or total of 100 MHz) above and below the highest point of the frequency range of RO #5 may be configured as the initial UL BWP. Alternatively, 10 MHz or 50 MHz (total of 20 MHz or total of 100 MHz) above and below the center frequency of the frequency range of RO #2 may be configured as the initial UL BWP of the RedCap UE.

(3) When the PRACH preamble is transmitted in RO #7, 10 MHz or 50 MHz (total of 20 MHz or total of 100 MHz) above and below based on the lowest point of the frequency range of RO #6 may be configured as the initial UL BWP of the RedCap UE. Alternatively, when the PRACH preamble is transmitted in RO #0, 10 MHz or 50 MHz (total of 20 MHz or total of 100 MHz) above and below the highest point of the frequency range of RO #1 may be configured as the initial UL BWP. Alternatively, 10 MHz or 50 MHz (total of 20 MHz or total of 100 MHz) above and below the center frequency of the frequency range of RO #5 may be configured as the initial UL BWP of the RedCap UE.

According to Method 2 to Method 3, since BW is not limited, Method 2 and Method 3 can be utilized without any change.

On the other hand, in Table 11, values corresponding to L_{RA}=571 and 1151 may be configured for the shared spectrum channel access. When the RedCap UE supports shared spectrum channel access and/or values corresponding to L_{RA}=571 and 1151 of Table 11, Methods 1 to 3 can be extended and applied based on the maximum initial UL BWP configured in the corresponding UE.

The various details, functions, procedures, proposals, methods, and/or operational flowcharts described above in this document may be applied to a variety of fields that require wireless communication/connection (e.g., 5G) between devices.

Hereinafter, a description will be given in detail with reference to drawings. In the following drawings/descriptions, the same reference numerals may denote the same or corresponding hardware blocks, software blocks, or functional blocks unless specified otherwise.

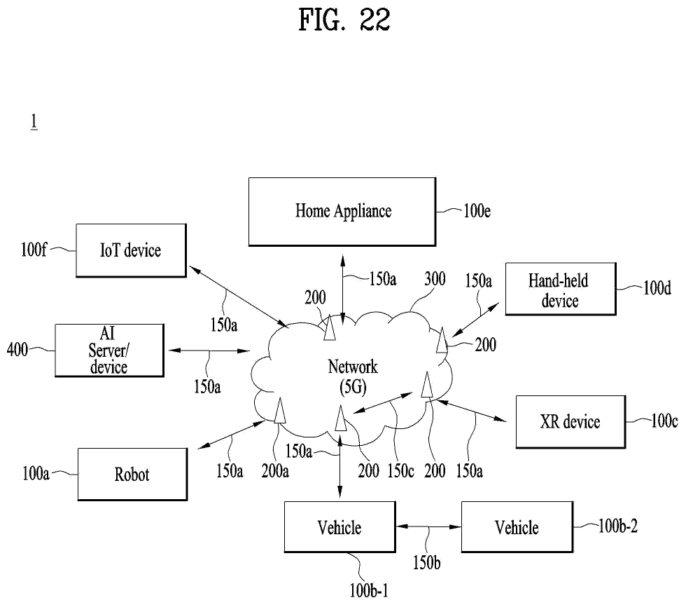

FIG. 22 illustrates a communication system 1 applied to the present disclosure.

Referring to FIG. 22, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smart pad, a wearable device (e.g., a smart watch or smart glasses), and a computer (e.g., a laptop). The home appliance may include a TV, a refrigerator, a washing machine, and so on. The IoT device may include a sensor, a smart meter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g. V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g. relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

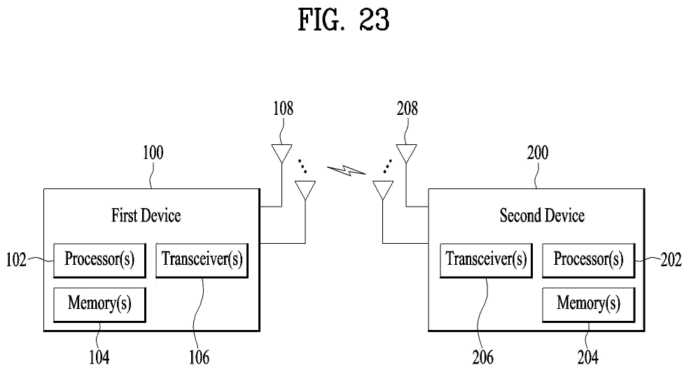

FIG. 23 illustrates wireless devices applicable to the present disclosure.

Referring to FIG. 23, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 22.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

Specifically, instructions and/or operations, controlled by the processor 102 of the first wireless device 100 and stored in the memory 104 of the first wireless device 100, according to an embodiment of the present disclosure will now be described.

Although the following operations will be described based on a control operation of the processor 102 in terms of the processor 102, software code for performing such an operation may be stored in the memory 104. For example, in the present disclosure, the at least one memory 104 may store instructions or programs as a computer-readable storage medium. The instructions or the programs may cause, when executed, at least one processor operably connected to the at least one memory to perform operations according to embodiments or implementations of the present disclosure, related to the following operations.

Specifically, the processor 102 may control the transceiver 106 to receive the best SSB or the 2^{nd} best SSB from among at least one SSB, and may measure the received SSB. In addition, the processor 102 may determine the initial UL BWP according to Method 1-1 and/or Method 1-2 of Method 1 based on the best SSB or the 2^{nd} best SSB. Meanwhile, the best SSB may refer to an SSB having the highest RSSI and/or the highest RSRP among at least one SSB received by the processor 102. Also, the 2^{nd} best SSB may refer to an SSB having a second highest RSSI and/or RSRP among at least one SSB received by the processor 102.

In addition, the processor 102 may control the transceiver 106 to transmit the PRACH Preamble through an RO mapped to the best SSB or 2^{nd} best SSB among the ROs included in the initial UL BWP. In this case, a method for mapping the best SSB or the 2^{nd} best SSB to the RO may be configured based on Method 2 and Method 3. In addition, a method for distinguishing the best SSB or the 2^{nd} best SSB from each other may be configured based on Method 3-1 and/or Method 3-2.

In addition, when the operation of the processor 102 is performed in FR1, the operation of the processor 102 can be based on Method 1 to Method 3-2. In contrast, when the operation of the processor 102 is performed in FR2, Method 4 can be additionally considered.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Specifically, instructions and/or operations, controlled by the processor 202 of the second wireless device 200 and stored in the memory 204 of the second wireless device 200, according to an embodiment of the present disclosure will now be described.

Although the following operations will be described based on a control operation of the processor 202 in terms of the processor 202, software code for performing such an operation may be stored in the memory 204. For example, in the present disclosure, the at least one memory 204 may store instructions or programs as a computer-readable storage medium. The instructions or the programs may cause, when executed, at least one processor operably connected to the at least one memory to perform operations according to embodiments or implementations of the present disclosure, related to the following operations.

Specifically, the processor 202 may control the transceiver 206 to transmit at least one SSB. In addition, the processor 202 may control the transceiver 206 to receive the PRACH preamble through the RO mapped to the best SSB or 2^{nd} best SSB measured by the UE among the ROs included in the initial UL BWP. In this case, the initial UL BWP may be determined according to Method 1-1 and/or Method 1-2 of Method 1.

In addition, the method for mapping the best SSB or the 2^{nd} best SSB to the RO may be configured based on Method 2 and Method 3. In addition, a method for the processor 202 to distinguish whether the received PRACH preamble was transmitted by the legacy UE or by the RedCap UE can be configured based on Method 3-1 and/or Method 3-2.

Meanwhile, the best SSB may refer to an SSB having the highest RSSI and/or the highest RSRP among at least one SSB received by the UE. Also, the 2^{nd} best SSB may refer to an SSB having a second highest RSSI and/or a second highest RSRP among at least one SSB received by the UE.

In addition, when the operation of the processor 202 is performed in FR1, the operation of the processor 202 can be based on Method 1 to Method 3-2. In contrast, when the operation of the processor 202 is performed in FR2, Method 4 can be additionally considered.

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

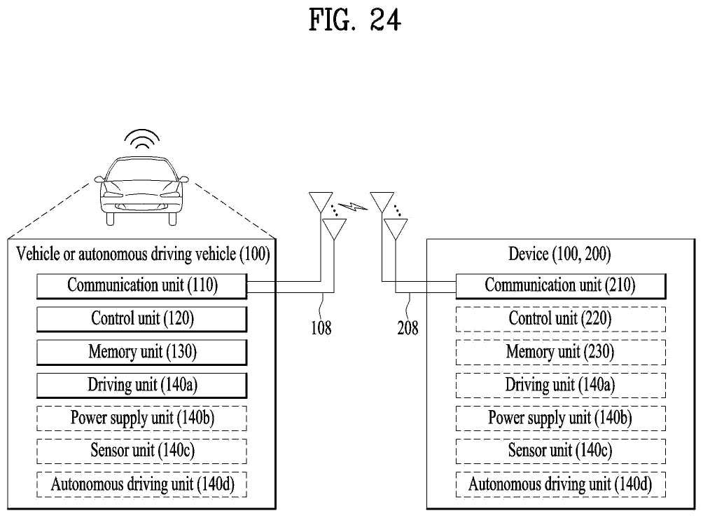

FIG. 24 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 24, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

The embodiments of the present disclosure described herein below are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It will be obvious to those skilled in the art that claims that are not explicitly cited in each other in the appended claims may be presented in combination as an embodiment of the present disclosure or included as a new claim by a subsequent amendment after the application is filed.

In the present disclosure, a specific operation described as performed by the BS may be performed by an upper node of the BS in some cases. Namely, it is apparent that, in a network comprised of a plurality of network nodes including a BS, various operations performed for communication with an MS may be performed by the BS, or network nodes other than the BS. The term ‘BS’ may be replaced with the term ‘fixed station’, ‘Node B’, ‘enhanced Node B (eNode B or eNB)’, ‘access point’, etc.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

Although the method and device for transmitting and receiving the random access channel (RACH) have been described focusing on examples applied to the 5th generation NewRAT system, the scope or spirit of the present disclosure is not limited thereto, and the above-described method and device can also be applied to various wireless communication systems other than the 5th generation NewRAT system.

1. A method for transmitting a physical random access channel (PRACH) preamble by a user equipment (UE) supporting communication associated with reduced capability (RedCap) in a wireless communication system, the method comprising:
receiving at least one synchronization signal block (SSB);
obtaining a random access channel (RACH) occasion (RO) to which a first SSB among the at least one SSB is mapped;
obtaining an initial uplink (UL) bandwidth part (BWP) based on the RACH occasion (RO); and
transmitting the PRACH preamble based on the RACH occasion (RO) and the initial UL BWP.

2. The method according to claim 1, wherein:
the initial UL BWP is an uplink bandwidth part (UL BWP) including the RACH occasion (RO) among a plurality of UL BWPs configured for the UE.

3. The method according to claim 1, wherein the obtaining the initial UL BWP includes:
determining a first frequency higher by the first unit from a first frequency range for the RACH occasion (RO);
determining a second frequency lower by a first unit from the first frequency range; and
determining a second frequency range from the first frequency to the second frequency to be the initial UL BWP.

4. The method according to claim 1, wherein:
the first SSB is a best SSB in which at least one of a measured received signal strength indicator (RSSI) and a measured reference signal received power (RSRP) has a highest value, among the at least one SSB.

5. The method according to claim 1, wherein:
a type of the UE is informed based on an index of the PRACH preamble.

6. A user equipment (UE) configured to support communication associated with reduced capability (RedCap) for transmitting a physical random access channel (PRACH) preamble in a wireless communication system, the UE comprising:
at least one transceiver;
at least one processor; and
at least one memory operatively connected to the at least one processor, and configured to store instructions such that the at least one processor, by executing the instructions, performs operations comprising:
receiving, through the at least one transceiver, at least one synchronization signal block (SSB);
obtaining a random access channel (RACH) occasion (RO) to which a first SSB among the at least one SSB is mapped;
obtaining an initial uplink (UL) bandwidth part (BWP) based on the RACH occasion (RO); and
transmitting, through the at least one transceiver, the PRACH preamble based on the RACH occasion (RO) and the initial UL BWP.

7. The user equipment (UE) according to claim 6, wherein:
the initial UL BWP is an uplink bandwidth part (UL BWP) including the RACH occasion (RO) among a plurality of UL BWPs configured for the UE.

8. The user equipment (UE) according to claim 6, wherein the obtaining the initial UL BWP includes:
determining a first frequency higher by a first unit from a first frequency range for the RACH occasion (RO);
determining a second frequency lower by the first unit from the first frequency range; and
determining a second frequency range from the first frequency to the second frequency to be the initial UL BWP.

9. The user equipment (UE) according to claim 6, wherein:
the first SSB is a best SSB in which at least one of a measured received signal strength indicator (RSSI) and a measured reference signal received power (RSRP) has a highest value, among the at least one SSB.

10. The user equipment (UE) according to claim 6, wherein:
a type of the UE is informed based on an index of the PRACH preamble.

11. (canceled)

12. (canceled)

13. A base station (BS) configured to support communication associated with reduced capability (RedCap) for receiving a physical random access channel (PRACH) preamble in a wireless communication system, the BS comprising:
at least one transceiver;
at least one processor; and
at least one memory operatively connected to the at least one processor, and configured to store instructions such that the at least one processor, by executing the instructions, performs operations comprising:
transmitting, through the at least one transceiver, at least one synchronization signal block (SSB); and
receiving, through the at least one transceiver, the PRACH preamble through a random access channel (RACH) occasion (RO) to which a first SSB among the at least one SSB is mapped and an initial uplink (UL) bandwidth part (BWP) which is based on the RACH occasion (RO).

14. (canceled)
